(19) United States
(12) Patent Application Publication
(10) Pub. No.: US 2024/0366343 A1
(43) Pub. Date: Nov. 7, 2024

(54) PRECISION ORTHODONTIC APPLIANCES AND METHODS OF MANUFACTURING SAME

(71) Applicant: ProSomnus Sleep Technologies, Inc., Pleasanton, CA (US)

(72) Inventors: Sung KIM, Pleasanton, CA (US); Leonard A. Liptak, Pleasanton, CA (US); Brittany Logan Austin, Walnut Creek, CA (US)

(21) Appl. No.: 18/646,657

(22) Filed: Apr. 25, 2024

Related U.S. Application Data
(60) Provisional application No. 63/461,697, filed on Apr. 25, 2023.

(51) Int. Cl. A61C 9/00; A61C 7/00

(52) U.S. Cl. CPC A61C 9/0006; A61C 7/002

(57) ABSTRACT

An appliance having an appliance body comprising a portion shaped to match a contour of a tooth in an arch is disclosed. The appliance body can couple to the arch to cover about 20% or more and about 99% or less of a surface of the tooth.

### CROSS-REFERENCE TO RELATED APPLICATIONS

This application claims priority to and the benefit of U.S. Provisional Patent Application Ser. No. 63/461,697, filed Apr. 25, 2023, and entitled “PRECISION ORTHODONTIC APPLIANCES AND METHODS OF MANUFACTURING SAME”, the disclosure of which is incorporated herein by reference in its entirety.

### TECHNICAL FIELD

This invention relates to orthodontic devices and related methods.

### BACKGROUND

Orthodontic devices, trays, or appliances are used in orthodontic treatment methodology. Orthodontic treatment involves movement of a dental patient's teeth to improved positions in proper alignment with each other. The development of orthodontic trays addresses many issues, offering patients a more discreet, comfortable, and convenient alternative to traditional braces. Orthodontic trays or appliances can be “suck-down” orthodontic trays or appliances, which can be made by having a piece of plastic heated by a machine to soften and then vacuum suctioned to the mold of a patient's teeth, and the excess material is trimmed and edges are smoothed to make the fit comfortable.

### SUMMARY

This Summary is provided to introduce a selection of concepts in simplified form that can be further described below in the Detailed Description. This Summary is not intended to identify key aspects or essential aspects of the claimed subject matter. All features of exemplary embodiments which can be described in this disclosure and can be not mutually exclusive can be combined with one another. Elements of one embodiment can be utilized in the other embodiments without further mention. Other aspects and features of the present invention will become apparent to those ordinarily skilled in the art upon review of the following description of specific embodiments in conjunction with any accompanying Figures.

The present disclosure relates to an appliance including: an appliance body including a portion shaped to match a contour of a tooth in an arch, the appliance body configured to couple to the arch to cover about 20% or more and about 99% or less of a surface of the tooth.

The present disclosure relates to an appliance, wherein the arch is a mandibular arch or a maxillary arch.

The present disclosure relates to an appliance, wherein the appliance body is configured to cover only a portion of an occlusal surface on the tooth or an anterior occlusal surface on the tooth.

The present disclosure relates to an appliance, wherein the appliance body is configured to cover up to 99% of an occlusal surface on the tooth or 99% of an anterior occlusal surface on the tooth.

The present disclosure relates to an appliance, wherein the appliance body has an opening to allow a tooth to tooth contact on an anterior occlusal surface through the opening.

The present disclosure relates to an appliance, wherein the appliance body is configured to cover only a portion of an incisor surface, a canine surface, a posterior occlusal surface, or any combination thereof.

The present disclosure relates to an appliance, wherein the appliance body is configured to cover only a portion of a molar surface or a premolar surface.

The present disclosure relates to an appliance, wherein the appliance body is configured to cover a plurality of teeth.

The present disclosure relates to an appliance, wherein the appliance body is configured to perform palatal expansion or maxillary expansion.

The present disclosure relates to an appliance, wherein the appliance body is configured to be coupled to a bone using a bone wire, a bone screw, a bone pin, or any combination thereof.

The present disclosure relates to an appliance, the appliance body has a thickness of from about 0.5 mm to about 5 mm.

The present disclosure relates to an appliance, further including: a clasp, a wire, a bar, or any combination thereof; or a strap, an affixed sleeve, a removable sleeve, a strap, an anterior hinge, a short or long Herbst, a jack screw, a Herbst hinge, or any combination thereof.

The present disclosure relates to an appliance, further including a sensor, a light emitting device, or any combination thereof.

The present disclosure relates to an appliance, further including a compliance chip, an electronic or microelectronic device, an electronic accessory to obtain data and communicates the data with another electronic device, or any combination thereof.

The present disclosure relates to a method for making an appliance, the method including: (a) importing into a computer aided design (CAD) computer program a digitized data set obtained from a three-dimensional scan of dentition to generate a three-dimensional electronic model of the dentition; (b) inputting data to define dimensions of an appliance to be made based on the three-dimensional scan and a shape of the appliance, wherein the shape is defined by an effect of the appliance on the dentition, a mandibular or maxillary structure, or an alignment of the dentition; (c) subtracting the three-dimensional electronic model of the dentition, and preserving the defined dimensions of the appliance, from an image of a virtual solid block or material to obtain an appliance data set; and (d) fabricating the appliance from a solid block or material based on the appliance data set, wherein the fabricated appliance has a pre-defined thickness.

The present disclosure relates to a method, wherein the manufacturing of the appliance includes an additive manufacturing method.

The present disclosure relates to a method, wherein the manufacturing of the appliance includes a fused deposit molding (FDM) additive manufacturing process, 3-dimensional printing, injection molding, or any combination thereof.

The present disclosure relates to a method, wherein the appliance is configured to cover only a portion of an occlusal surface on a tooth.

The present disclosure relates to a method, wherein the appliance is configured to cover up to 99% of an occlusal surface on a tooth.

The present disclosure relates to a kit including at least one 1, and instructions for using the appliance.

The details of one or more exemplary embodiments of the invention are set forth in the accompanying drawings and the description below. Other features, objects, and advantages of the invention will be apparent from the description and drawings, and from the claims.

All publications, patents, patent applications, cited herein are hereby expressly incorporated by reference in their entireties for all purposes.

### DESCRIPTION OF DRAWINGS

The drawings set forth herein are illustrative of exemplary embodiments provided herein and are not meant to limit the scope of the invention as encompassed by the claims.

FIG. 1 illustrates orthodontic devices or appliances fabricated to allow for tooth to tooth contact on occlusal surfaces in some embodiments.

FIG. 2 illustrates an orthodontic device or appliance fabricated with respect to achieving molar to molar distances according to a setup model or target model.

Like reference symbols in the various drawings indicate like elements.

### DETAILED DESCRIPTION

Current “suck-down” orthodontic trays or appliances (made by having a piece of plastic heated by a machine to soften and then vacuum suctioned to the mold of a patient's teeth; and the excess material is trimmed and edges are smoothed to make the fit comfortable) have no thickness control. In fact, the suck-down-made tray or appliance is thinnest around a tooth cusp and other occlusal surfaces where the tray or appliance needs to be thicker to apply torque and rotation and other needed movement for orthodontic treatment.

One of the problems with clear aligner tray ortho treatment is when the patient wears both an upper and a lower tray or appliance, and the patient will not be able to have tooth to tooth contact as the trays, retainers or appliances cover the occlusal of anterior teeth at the front of the mouth resulting in the patient biting down onto the tray, retainer or appliance. Over time, this can cause the teeth to shift and result in retroclined upper anterior teeth as well as a lack of overjet. This problem cannot be corrected using trays made by the vacuum or “suck-down” technique.

Additionally, achieving molar to molar distance according to a setup model or target model is difficult for a vacuum or “suck-down” technique tray system as its spring force is weaker than metal wires, and this tray system loses its elasticity very quickly.

The present disclosure relates to an appliance including an appliance body having a thicknesses to cover 99% or less of a surface of a tooth in an arch. The present disclosure relates to an orthodontic appliance comprising an appliance body to couple to an arch to cover about 99% or less of a surface of a tooth in the arch. In some embodiments, the appliance body is configured to cover about 95% or less of a surface of a tooth in an arch. In some embodiments, the appliance body is configured to cover about 90% or less of a surface of a tooth in an arch. In some embodiments, the appliance body is configured to cover about 85% or less of a surface of a tooth in an arch. In some embodiments, the appliance body is configured to cover about 90% or less of a surface of a tooth in an arch. In some embodiments, the appliance body is configured to cover about 85% or less of a surface of a tooth in an arch. In some embodiments, the appliance body is configured to cover about 80% or less of a surface of a tooth in an arch. In some embodiments, the appliance body is configured to cover about 70% or less of a surface of a tooth in an arch. In some embodiments, the appliance body is configured to cover about 65% or less of a surface of a tooth in an arch. In some embodiments, the appliance body is configured to cover about 60% or less of a surface of a tooth in an arch. In some embodiments, the appliance body is configured to cover about 55% or less of a surface of a tooth in an arch. In some embodiments, the appliance body is configured to cover about 50% or less of a surface of a tooth in an arch. In some embodiments, the appliance body is configured to cover about 45% or less of a surface of a tooth in an arch. In some embodiments, the appliance body is configured to cover about 40% or less of a surface of a tooth in an arch. In some embodiments, the appliance body is configured to cover about 30% or less of a surface of a tooth in an arch. In some embodiments, the appliance body is configured to cover about 20% or less of a surface of a tooth in an arch. In some embodiments, the appliance body is configured to cover about 10% or less of a surface of a tooth in an arch. In some embodiments, the appliance body is configured to cover about 5% or less of a surface of a tooth in an arch.

In some embodiments, the appliance body is configured to cover up to about 1% of a surface of a tooth in an arch. In some embodiments, the appliance body is configured to cover up to about 5% of a surface of a tooth in an arch. In some embodiments, the appliance body is configured to cover up to about 10% of a surface of a tooth in an arch. In some embodiments, the appliance body is configured to cover up to about 15% of a surface of a tooth in an arch. In some embodiments, the appliance body is configured to cover up to about 18% of a surface of a tooth in an arch. In some embodiments, the appliance body is configured to cover up to about 20% of a surface of a tooth in an arch. In some embodiments, the appliance body is configured to cover up to about 25% of a surface of a tooth in an arch. In some embodiments, the appliance body is configured to cover up to about 30% of a surface of a tooth in an arch. In some embodiments, the appliance body is configured to cover up to about 35% of a surface of a tooth in an arch. In some embodiments, the appliance body is configured to cover up to about 40% of a surface of a tooth in an arch. In some embodiments, the appliance body is configured to cover up to about 45% of a surface of a tooth in an arch. In some embodiments, the appliance body is configured to cover up to about 50% of a surface of a tooth in an arch. In some embodiments, the appliance body is configured to cover up to about 55% of a surface of a tooth in an arch. In some embodiments, the appliance body is configured to cover up to about 60% of a surface of a tooth in an arch. In some embodiments, the appliance body is configured to cover up to about 65% of a surface of a tooth in an arch. In some embodiments, the appliance body is configured to cover up to about 70% of a surface of a tooth in an arch. In some embodiments, the appliance body is configured to cover up to about 75% of a surface of a tooth in an arch. In some embodiments, the appliance body is configured to cover up to about 80% of a surface of a tooth in an arch. In some embodiments, the appliance body is configured to cover up to about 85% of a surface of a tooth in an arch. In some embodiments, the appliance body is configured to cover up to about 90% of a surface of a tooth in an arch. In some embodiments, the appliance body is configured to cover up to about 92% of a surface of a tooth in an arch. In some embodiments, the appliance body is configured to cover up to about 95% of a surface of a tooth in an arch. In some embodiments, the appliance body is configured to cover up to about 98% of a surface of a tooth in an arch. In some embodiments, the appliance body is configured to cover up to about 99% of a surface of a tooth in an arch. In some embodiments, the appliance body is configured to cover up to about 99.5% or more of a surface of a tooth in an arch.

In some embodiments, the appliance body is configured to cover from about 1% to about 99% of a surface of a tooth in an arch. In some embodiments, the appliance body is configured to cover from about 5% to about 99% of a surface of a tooth in an arch. In some embodiments, the appliance body is configured to cover from about 10% to about 99% of a surface of a tooth in an arch. In some embodiments, the appliance body is configured to cover from about 20% to about 99% of a surface of a tooth in an arch. In some embodiments, the appliance body is configured to cover from about 25% to about 90% of a surface of a tooth in an arch. In some embodiments, the appliance body is configured to cover from about 25% to about 85% of a surface of a tooth in an arch. In some embodiments, the appliance body is configured to cover from about 30% to about 80% of a surface of a tooth in an arch. In some embodiments, the appliance body is configured to cover from about 35% to about 75% of a surface of a tooth in an arch. In some embodiments, the appliance body is configured to cover from about 35% to about 70% of a surface of a tooth in an arch. In some embodiments, the appliance body is configured to cover from about 50% to about 90% of a surface of a tooth in an arch. In some embodiments, the appliance body is configured to cover from about 40% to about 80% of a surface of a tooth in an arch. In some embodiments, the appliance body is configured to cover from about 30% to about 99% of a surface of a tooth in an arch. In some embodiments, the appliance body is configured to cover from about 40% to about 99% of a surface of a tooth in an arch.

The present disclosure relates to an appliance including an appliance body having a thicknesses to cover 99% or less of a surface of dentition in an arch. The present disclosure relates to an orthodontic appliance comprising an appliance body configured to couple to an arch to cover about 99% or less of a surface of a tooth in the arch. In some embodiments, the appliance body is configured to cover about 95% or less of a surface of dentition in an arch. In some embodiments, the appliance body is configured to cover about 90% or less of a surface of dentition in an arch. In some embodiments, the appliance body is configured to cover about 85% or less of a surface of dentition in an arch. In some embodiments, the appliance body is configured to cover about 90% or less of a surface of dentition in an arch. In some embodiments, the appliance body is configured to cover about 85% or less of a surface of dentition in an arch. In some embodiments, the appliance body is configured to cover about 80% or less of a surface of dentition in an arch. In some embodiments, the appliance body is configured to cover about 70% or less of a surface of dentition in an arch. In some embodiments, the appliance body is configured to cover about 65% or less of a surface of dentition in an arch. In some embodiments, the appliance body is configured to cover about 60% or less of a surface of dentition in an arch. In some embodiments, the appliance body is configured to cover about 55% or less of a surface of dentition in an arch. In some embodiments, the appliance body is configured to cover about 50% or less of a surface of dentition in an arch. In some embodiments, the appliance body is configured to cover about 45% or less of a surface of dentition in an arch. In some embodiments, the appliance body is configured to cover about 40% or less of a surface of dentition in an arch. In some embodiments, the appliance body is configured to cover about 30% or less of a surface of dentition in an arch. In some embodiments, the appliance body is configured to cover about 25% or less of a surface of dentition in an arch. In some embodiments, the appliance body is configured to cover about 20% or less of a surface of dentition in an arch. In some embodiments, the appliance body is configured to cover about 15% or less of a surface of dentition in an arch. In some embodiments, the appliance body is configured to cover about 10% or less of a surface of dentition in an arch. In some embodiments, the appliance body is configured to cover about 5% or less of a surface of dentition in an arch.

In some embodiments, the appliance body is configured to cover up to about 5% of a surface of dentition in an arch. In some embodiments, the appliance body is configured to cover up to about 10% of a surface of dentition in an arch. In some embodiments, the appliance body is configured to cover up to about 15% of a surface of dentition in an arch. In some embodiments, the appliance body is configured to cover up to about 20% of a surface of dentition in an arch. In some embodiments, the appliance body is configured to cover up to about 25% of a surface of dentition in an arch. In some embodiments, the appliance body is configured to cover up to about 30% of a surface of dentition in an arch. In some embodiments, the appliance body is configured to cover up to about 35% of a surface of dentition in an arch. In some embodiments, the appliance body is configured to cover up to about 40% of a surface of dentition in an arch. In some embodiments, the appliance body is configured to cover up to about 45% of a surface of dentition in an arch. In some embodiments, the appliance body is configured to cover up to about 50% of a surface of dentition in an arch. In some embodiments, the appliance body is configured to cover up to about 55% of a surface of dentition in an arch. In some embodiments, the appliance body is configured to cover up to about 60% of a surface of dentition in an arch. In some embodiments, the appliance body is configured to cover up to about 65% of a surface of dentition in an arch. In some embodiments, the appliance body is configured to cover up to about 70% of a surface of dentition in an arch. In some embodiments, the appliance body is configured to cover up to about 75% of a surface of dentition in an arch. In some embodiments, the appliance body is configured to cover up to about 80% of a surface of dentition in an arch. In some embodiments, the appliance body is configured to cover up to about 85% of a surface of dentition in an arch. In some embodiments, the appliance body is configured to cover up to about 90% of a surface of dentition in an arch. In some embodiments, the appliance body is configured to cover up to about 92% of a surface of dentition in an arch. In some embodiments, the appliance body is configured to cover up to about 95% of a surface of dentition in an arch. In some embodiments, the appliance body is configured to cover up to about 98% of a surface of dentition in an arch. In some embodiments, the appliance body is configured to cover up to about 99% of a surface of dentition in an arch. In some embodiments, the appliance body is configured to cover up to about 99.5% or more of a surface of dentition in an arch.

In some embodiments, the appliance body is configured to cover from about 1% to about 99% of a surface of dentition in an arch. In some embodiments, the appliance body is configured to cover from about 3% to about 99% of a surface of dentition in an arch. In some embodiments, the appliance body is configured to cover from about 5% to about 99% of a surface of dentition in an arch. In some embodiments, the appliance body is configured to cover from about 10% to about 99% of a surface of dentition in an arch. In some embodiments, the appliance body is configured to cover from about 15% to about 99% of a surface of dentition in an arch. In some embodiments, the appliance body is configured to cover from about 20% to about 99% of a surface of dentition in an arch. In some embodiments, the appliance body is configured to cover from about 25% to about 90% of a surface of dentition in an arch. In some embodiments, the appliance body is configured to cover from about 25% to about 85% of a surface of dentition in an arch. In some embodiments, the appliance body is configured to cover from about 30% to about 80% of a surface of dentition in an arch. In some embodiments, the appliance body is configured to cover from about 35% to about 75% of a surface of dentition in an arch. In some embodiments, the appliance body is configured to cover from about 35% to about 70% of a surface of dentition in an arch. In some embodiments, the appliance body is configured to cover from about 50% to about 90% of a surface of dentition in an arch. In some embodiments, the appliance body is configured to cover from about 40% to about 80% of a surface of dentition in an arch. In some embodiments, the appliance body is configured to cover from about 30% to about 99% of a surface of dentition in an arch. In some embodiments, the appliance body is configured to cover from about 40% to about 99% of a surface of dentition in an arch.

In some embodiments, the arch is a mandibular (lower) arch or a maxillary (upper) arch.

In some embodiments, the appliance body is configured to cover only a portion of an occlusal surface on the tooth.

In some embodiments, the appliance body is configured to cover up to 99% of an occlusal surface on the tooth.

In some embodiments, the appliance body is configured to cover only a portion of an anterior occlusal surface.

In some embodiments, the appliance body is configured to allow a tooth to tooth contact on an anterior occlusal surface.

In some embodiments, the appliance body has an opening to allow a tooth to tooth contact on an anterior occlusal surface through the opening.

In some embodiments, the appliance body is configured to cover only a portion of an incisor surface, a canine surface, or the incisor and canine surfaces.

In some embodiments, the appliance body is configured to allow a tooth to tooth contact on an incisor surface, a canine surface, or the incisor and canine surfaces.

In some embodiments, the appliance body has an opening to allow a tooth to tooth contact on an incisor surface, a canine surface, or the incisor and canine surfaces through the opening.

In some embodiments, the appliance body is configured to cover only a portion of a posterior occlusal surface.

In some embodiments, the appliance body is configured to cover only a portion of anterior occlusal surface and a posterior occlusal surface.

In some embodiments, the appliance body is configured to cover only a portion of a molar surface or a premolar surface.

In some embodiments, the appliance body is configured to cover only a portion of a molar surface, a premolar surface. Or the molar and premolar surfaces.

In some embodiments, the appliance body is configured to cover only a portion of an incisor surface, a canine surface, or the incisor and canine surfaces; and a molar surface, a premolar surface, or the molar and premolar surfaces.

In some embodiments, the appliance body is configured to cover only a portion 1, wherein the appliance body is to cover only a portion of a maxillary (upper arch) arch.

In some embodiments, the appliance body is configured to cover a maxillary (upper arch) arch and only a portion of a mandibular (lower) arch.

In some embodiments, the appliance body is configured to cover a mandibular (lower) arch and only a portion of a maxillary (upper arch) arch.

In some embodiments, the appliance body is configured to cover only one, two, three, four, five, six, seven, eight, nine, ten, eleven, twelve, thirteen, fourteen, or fifteen teeth.

In some embodiments, the appliance body is configured to move a tooth.

In some embodiments, the appliance body is configured to stabilize a position of a tooth.

In some embodiments, the appliance body is configured to perform palatal expansion.

In some embodiments, the appliance body is configured to perform maxillary expansion.

In some embodiments, the appliance body is configured to be coupled to a bone.

In some embodiments, the appliance body is configured to be coupled to a bone using a bone wire, a bone screw, a bone pin.

In some embodiments, the appliance body has a thickness that is at least substantially consistent throughout at least a portion of the appliance.

In some embodiments, the appliance body has a thickness of from about 0.5 mm to about 5 mm.

In some embodiments, the appliance body has a thickness of about 0.5 mm, about 1 mm, about 1.5 mm, about 2 mm, about 2.5 mm or about 3 mm.

In some embodiments, the appliance body has a thicknesses at least substantially varied throughout at least a portion of the appliance.

In some embodiments, the appliance body has a thicknesses at least substantially varied throughout at least a portion of the appliance such that cusp tips or occlusal contact points are pre-defined to have an at least substantially consistent thickness.

In some embodiments, the appliance body has cusp tips or occlusal contact points having a thickness of from about 0.2 mm to about 2 mm.

In some embodiments, the appliance body has cusp tips or occlusal contact points having a thickness of from about 0.5 mm to about 1.5 mm.

In some embodiments, the appliance body has a thicknesses at least substantially varied throughout at least a portion of the appliance such that supporting or non-occlusal sections of the appliance have a different thickness relative to another portion of the appliance body.

In some embodiments, the appliance body has a thicknesses at least substantially varied throughout at least a portion of the appliance such that supporting or non-occlusal sections of the appliance have a thicker thickness relative to another portion of the appliance body.

In some embodiments, the appliance body has supporting or non-occlusal sections of the appliance having a thickness of about 2 mm to about 5 mm.

In some embodiments, the appliance body has supporting or non-occlusal sections of the appliance having a thickness of about 2 mm to about 2.5 mm.

In some embodiments, the appliance body has a thickness to be able to apply varying amounts of retentive forces or orthodontic movement forces to dentition, or to stimulate or generate movement by mandible or maxilla.

In some embodiments, the appliance body can further include a clasp, a wire, a bar, or any combination thereof.

In some embodiments, the appliance body can further include a strap, an affixed sleeve, a removable sleeve, a strap, an anterior hinge, a short or long Herbst, a jack screw, a Herbst hinge, or a combination thereof.

In some embodiments, the appliance body can further include a sensor, a light emitting device, or a combination thereof.

In some embodiments, the appliance body can further include a flexible sensor, an inflexible sensor.

In some embodiments, the appliance body can further include a light detection device as a sensor.

In some embodiments, the appliance body can further include a compliance chip, an electronic or microelectronic device, an electronic accessory to obtain data and communicates the data with another electronic device, or a combination thereof.

In some embodiments, the orthodontic appliance includes poly(butylene succinate) or copolymers thereof, polymethyl-methacrylate (PMMA), lined PMMA, high-strength polyether ether ketone (PEEK), a (meth)acryloyloxy-substituted benzoic acid ester, urethane di(meth)acrylate (UDMA), triethyleneglycol dimethacrylate (TEGDMA), tetraethylene glycol diacrylate (E4-A), trimethylolpropanetriacrylate (TTA), a polymer matrix including diurethanedimethacrylate (DUDMA) and glycerol dimethacrylate (GDMA), a polymer produced from polyoxymethylene and acetal copolymers (DURACETAL®), glycol modified polyethylene terephthalate (PET), wood, plastic, a metal, or a combination thereof.

In some embodiments, the orthodontic appliance is made or fabricated from poly(butylene succinate) or copolymers thereof, polymethyl-methacrylate (PMMA), lined PMMA, high-strength polyether ether ketone (PEEK), a (meth)acryloyloxy-substituted benzoic acid ester, urethane di(meth)acrylate (UDMA), triethyleneglycol dimethacrylate (TEGDMA), tetraethylene glycol diacrylate (E4-A), trimethylolpropanetriacrylate (TTA), a polymer matrix including diurethanedimethacrylate (DUDMA) and glycerol dimethacrylate (GDMA), a polymer produced from polyoxymethylene and acetal copolymers (DURACETAL®), glycol modified polyethylene terephthalate (PET), wood, plastic, a metal, or a combination thereof.

The present disclosure relates to an appliance including: an appliance body including a portion shaped to match a contour of a tooth in an arch, the appliance body configured to couple to the arch to cover about 20% or more and about 99% or less of a surface of the tooth.

The present disclosure relates to an appliance, wherein the arch is a mandibular arch or a maxillary arch.

The present disclosure relates to an appliance, wherein the appliance body is configured to cover only a portion of an occlusal surface on the tooth or an anterior occlusal surface on the tooth.

The present disclosure relates to an appliance, wherein the appliance body is configured to cover up to 99% of an occlusal surface on the tooth or 99% of an anterior occlusal surface on the tooth.

The present disclosure relates to an appliance, wherein the appliance body has an opening to allow a tooth to tooth contact on an anterior occlusal surface through the opening.

The present disclosure relates to an appliance, wherein the appliance body is configured to cover only a portion of an incisor surface, a canine surface, a posterior occlusal surface, or any combination thereof.

The present disclosure relates to an appliance, wherein the appliance body is configured to cover only a portion of a molar surface or a premolar surface.

The present disclosure relates to an appliance, wherein the appliance body is configured to cover a plurality of teeth.

The present disclosure relates to an appliance, wherein the appliance body is configured to perform palatal expansion or maxillary expansion.

The present disclosure relates to an appliance, wherein the appliance body is configured to be coupled to a bone using a bone wire, a bone screw, a bone pin, or any combination thereof.

The present disclosure relates to an appliance, the appliance body has a thickness of from about 0.5 mm to about 5 mm.

The present disclosure relates to an appliance, further including: a clasp, a wire, a bar, or any combination thereof; or a strap, an affixed sleeve, a removable sleeve, a strap, an anterior hinge, a short or long Herbst, a jack screw, a Herbst hinge, or any combination thereof.

The present disclosure relates to an appliance, further including a sensor, a light emitting device, or any combination thereof.

The present disclosure relates to an appliance, further including a compliance chip, an electronic or microelectronic device, an electronic accessory to obtain data and communicates the data with another electronic device, or any combination thereof.

The present disclosure relates to a method for making an appliance, the method including: (a) importing into a computer aided design (CAD) computer program a digitized data set obtained from a three-dimensional scan of dentition to generate a three-dimensional electronic model of the dentition; (b) inputting data to define dimensions of an appliance to be made based on the three-dimensional scan and a shape of the appliance, wherein the shape is defined by an effect of the appliance on the dentition, a mandibular or maxillary structure, or an alignment of the dentition; (c) subtracting the three-dimensional electronic model of the dentition, and preserving the defined dimensions of the appliance, from an image of a virtual solid block or material to obtain an appliance data set; and (d) fabricating the appliance from a solid block or material based on the appliance data set, wherein the fabricated appliance has a pre-defined thickness.

The present disclosure relates to a method, wherein the manufacturing of the appliance includes an additive manufacturing method.

The present disclosure relates to a method, wherein the manufacturing of the appliance includes a fused deposit molding (FDM) additive manufacturing process, 3-dimensional printing, injection molding, or any combination thereof.

The present disclosure relates to a method, wherein the appliance is configured to cover only a portion of an occlusal surface on a tooth.

The present disclosure relates to a method, wherein the appliance is configured to cover up to 99% of an occlusal surface on a tooth.

The present disclosure relates to a kit including at least one 1, and instructions for using the appliance.

The present disclosure relates to an orthodontic appliance made by a process including: (a) importing into a computer aided design (CAD) computer program a digitized data set obtained from a three-dimensional scan of dentition to generate a three-dimensional electronic model of the dentition; (b) inputting data to define dimensions of an orthodontic appliance to be made based on the three-dimensional scan and a shape of the orthodontic appliance, wherein the shape is defined by an effect of the orthodontic appliance on the dentition, a mandibular or maxillary structure, or an alignment of the dentition; (c) subtracting the three-dimensional electronic model of the dentition, and preserving the defined dimensions of the orthodontic appliance, from an image of a virtual solid block or material to obtain an appliance data set; and (d) manufacturing the orthodontic appliance from a solid block or material based on the appliance data set, wherein the manufactured orthodontic appliance has a pre-defined thickness.

In some embodiments, the manufacturing of the orthodontic appliance includes an additive manufacturing method.

In some embodiments, the manufacturing of the orthodontic appliance includes a fused deposit molding (FDM) additive manufacturing process, 3-dimensional printing, injection molding, or a combination thereof.

In some embodiments, the manufacturing of the orthodontic appliance includes a subtractive manufacturing method.

In some embodiments, the manufacturing of the orthodontic appliance includes carving, milling, or a combination thereof.

In some embodiments, the orthodontic appliance is configured to cover only a portion of an occlusal surface on a tooth.

In some embodiments, the orthodontic appliance is configured to cover up to 99% of an occlusal surface on a tooth.

In some embodiments, the orthodontic appliance is configured to move a tooth.

In some embodiments, the orthodontic appliance is configured to stabilize a position of a tooth.

In some embodiments, the orthodontic appliance is configured to perform mandibular or maxillary expansion.

In some embodiments, the orthodontic appliance is configured to be coupled to a bone.

For example, in some embodiments, the orthodontic appliance is configured to be coupled to a bone using a bone wire, a bone screw, a bone pin.

In some embodiments, the orthodontic appliance is configured to cover only a portion of an anterior occlusal surface.

In some embodiments, the orthodontic appliance is configured to allow a tooth to tooth contact on an anterior occlusal surface.

In some embodiments, the orthodontic appliance has an opening to allow a tooth to tooth contact on an anterior occlusal surface through the opening.

In some embodiments, the orthodontic appliance is configured to cover only a portion of an incisor surface, a canine surface, or the incisor and canine surfaces.

In some embodiments, the orthodontic appliance is configured to allow a tooth to tooth contact on an incisor surface, a canine surface, or the incisor and canine surfaces.

In some embodiments, the orthodontic appliance has an opening to allow a tooth to tooth contact on an incisor surface, a canine surface, or the incisor and canine surfaces through the opening.

In some embodiments, the orthodontic appliance is configured to cover only a portion of a posterior occlusal surface.

In some embodiments, the orthodontic appliance is configured to cover only a portion of anterior occlusal surface and a posterior occlusal surface.

In some embodiments, the orthodontic appliance is configured to cover only a portion of a molar surface or a premolar surface.

In some embodiments, the orthodontic appliance is configured to cover only a portion of a molar surface, a premolar surface. Or the molar and premolar surfaces.

In some embodiments, the orthodontic appliance is configured to cover only a portion of: an incisor surface, a canine surface, or the incisor and canine surfaces; and a molar surface, a premolar surface, or the molar and premolar surfaces.

In some embodiments, the appliance body can further include a clasp, a wire, a bar, or any combination thereof.

In some embodiments, the appliance body can further include a strap, an affixed sleeve, a removable sleeve, a strap, an anterior hinge, a short or long Herbst, a jack screw, a Herbst hinge, or a combination thereof.

In some embodiments, the appliance body can further include a sensor, a light emitting device, or a combination thereof.

In some embodiments, the appliance body can further include a flexible sensor, an inflexible sensor.

In some embodiments, the appliance body can further include a light detection device as a sensor.

In some embodiments, the appliance body can further include a compliance chip, an electronic or microelectronic device, an electronic accessory to obtain data and communicates the data with another electronic device, or a combination thereof.

In some embodiments, the orthodontic appliance includes poly(butylene succinate) or copolymers thereof, polymethyl-methacrylate (PMMA), lined PMMA, high-strength polyether ether ketone (PEEK), a (meth)acryloyloxy-substituted benzoic acid ester, urethane di(meth)acrylate (UDMA), triethyleneglycol dimethacrylate (TEGDMA), tetraethylene glycol diacrylate (E4-A), trimethylolpropanetriacrylate (TTA), a polymer matrix including diurethanedimethacrylate (DUDMA) and glycerol dimethacrylate (GDMA), a polymer produced from polyoxymethylene and acetal copolymers (DURACETAL®), glycol modified polyethylene terephthalate (PET), wood, plastic, a metal, or a combination thereof.

In some embodiments, the orthodontic appliance is made or fabricated from poly(butylene succinate) or copolymers thereof, polymethyl-methacrylate (PMMA), lined PMMA, high-strength polyether ether ketone (PEEK), a (meth)acryloyloxy-substituted benzoic acid ester, urethane di(meth)acrylate (UDMA), triethyleneglycol dimethacrylate (TEGDMA), tetraethylene glycol diacrylate (E4-A), trimethylolpropanetriacrylate (TTA), a polymer matrix including diurethanedimethacrylate (DUDMA) and glycerol dimethacrylate (GDMA), a polymer produced from polyoxymethylene and acetal copolymers (DURACETAL®), glycol modified polyethylene terephthalate (PET), wood, plastic, a metal, or a combination thereof.

The present disclosure also relates to a method for making an orthodontic appliance, the method including: (a) importing into a computer aided design (CAD) computer program a digitized data set obtained from a three-dimensional scan of dentition to generate a three-dimensional electronic model of the dentition; (b) inputting data to define dimensions of an orthodontic appliance to be made based on the three-dimensional scan and a shape of the orthodontic appliance, wherein the shape is defined by an effect of the orthodontic appliance on the dentition, a mandibular or maxillary structure, or an alignment of the dentition; (c) subtracting the three-dimensional electronic model of the dentition, and preserving the defined dimensions of the orthodontic appliance, from an image of a virtual solid block or material to obtain an appliance data set; and (d) fabricating the orthodontic appliance from a solid block or material based on the appliance data set, wherein the fabricated orthodontic appliance has a pre-defined thickness.

In some embodiments, the manufacturing of the dental appliance includes an additive manufacturing method.

In some embodiments, the manufacturing of the orthodontic appliance includes a fused deposit molding (FDM) additive manufacturing process, 3-dimensional printing, injection molding, or a combination thereof.

In some embodiments, the manufacturing of the orthodontic appliance includes a subtractive manufacturing method.

In some embodiments, the manufacturing of the orthodontic appliance includes carving, milling, or a combination thereof.

In some embodiments, the orthodontic appliance is configured to cover only a portion of an occlusal surface on a tooth.

In some embodiments, the orthodontic appliance is configured to cover up to 99% of an occlusal surface on a tooth.

In some embodiments, the orthodontic appliance is configured to move a tooth.

In some embodiments, the orthodontic appliance is configured to stabilize a position of a tooth.

In some embodiments, the orthodontic appliance is configured to perform mandibular or maxillary expansion.

In some embodiments, the orthodontic appliance is configured to be coupled to a bone.

In some embodiments, the orthodontic appliance is configured to be coupled to a bone using a bone wire, a bone screw, a bone pin.

In some embodiments, the orthodontic appliance is configured to cover only a portion of an anterior occlusal surface.

In some embodiments, the orthodontic appliance is configured to allow a tooth to tooth contact on an anterior occlusal surface.

In some embodiments, the orthodontic appliance has an opening to allow a tooth to tooth contact on an anterior occlusal surface through the opening.

In some embodiments, the orthodontic appliance is to cover only a portion of an incisor surface, a canine surface, or the incisor and canine surfaces.

In some embodiments, the orthodontic appliance is configured to allow a tooth to tooth contact on an incisor surface, a canine surface, or the incisor and canine surfaces.

In some embodiments, the orthodontic appliance has an opening to allow a tooth to tooth contact on an incisor surface, a canine surface, or the incisor and canine surfaces through the opening.

In some embodiments, the orthodontic appliance is configured to cover only a portion of a posterior occlusal surface.

In some embodiments, the orthodontic appliance is configured to cover only a portion of anterior occlusal surface and a posterior occlusal surface.

In some embodiments, the orthodontic appliance is configured to cover only a portion of a molar surface or a premolar surface.

In some embodiments, the orthodontic appliance is configured to cover only a portion of a molar surface, a premolar surface. Or the molar and premolar surfaces.

In some embodiments, the orthodontic appliance is configured to cover only a portion of: an incisor surface, a canine surface, or the incisor and canine surfaces; and a molar surface, a premolar surface, or the molar and premolar surfaces.

In some embodiments, the orthodontic appliance includes poly(butylene succinate) or copolymers thereof, polymethyl-methacrylate (PMMA), lined PMMA, high-strength polyether ether ketone (PEEK), a (meth)acryloyloxy-substituted benzoic acid ester, urethane di(meth)acrylate (UDMA), triethyleneglycol dimethacrylate (TEGDMA), tetraethylene glycol diacrylate (E4-A), trimethylolpropanetriacrylate (TTA), a polymer matrix including diurethanedimethacrylate (DUDMA) and glycerol dimethacrylate (GDMA), a polymer produced from polyoxymethylene and acetal copolymers (DURACETAL®), glycol modified polyethylene terephthalate (PET), wood, plastic, a metal, or a combination thereof.

In some embodiments, the orthodontic appliance is made or fabricated from poly(butylene succinate) or copolymers thereof, polymethyl-methacrylate (PMMA), lined PMMA, high-strength polyether ether ketone (PEEK), a (meth)acryloyloxy-substituted benzoic acid ester, urethane di(meth)acrylate (UDMA), triethyleneglycol dimethacrylate (TEGDMA), tetraethylene glycol diacrylate (E4-A), trimethylolpropanetriacrylate (TTA), a polymer matrix including diurethanedimethacrylate (DUDMA) and glycerol dimethacrylate (GDMA), a polymer produced from polyoxymethylene and acetal copolymers (DURACETAL®), glycol modified polyethylene terephthalate (PET), wood, plastic, a metal, or a combination thereof.

The present disclosure also discloses a kit that includes at least one orthodontic appliance.

In some embodiments, the kit includes both a mandibular (lower) arch orthodontic appliance being the orthodontic appliance and a maxillary (upper) arch orthodontic appliance 1, or a set 1.

In some embodiments, the kit includes a plurality of orthodontic appliances, wherein each of the plurality of mandibular orthodontic appliances has a different design or shape from another.

In some embodiments, the kit includes a plurality of orthodontic appliance, wherein the plurality of mandibular orthodontic appliances are designed to be consecutively coupled to the dentition for mandibular tooth movement or mandibular or palatal expansion.

In some embodiments, the kit includes a plurality of maxillary (upper) arch orthodontic appliances each being the orthodontic appliance, wherein each of the plurality of maxillary orthodontic appliances has a different design or shape from another.

In some embodiments, the kit includes a plurality of orthodontic appliance, wherein the plurality of maxillary orthodontic appliances is designed to be consecutively coupled to dentition for maxillary tooth movement or palatal or maxillary expansion.

The present disclosure also discloses use of orthodontic appliance for treating, preventing or ameliorating sleep apnea, teeth grinding, an improperly positioned mandible or maxilla, a prognathic or a retrognathic maxilla or mandible, and/or a malocclusion or condition, wherein optionally the malocclusion or condition include a Class I, Class II or Class III malocclusion, or the malocclusion or condition includes an overbite, underbite (or anterior crossbite), crossbite, overcrowding, spacing problem, open bite, overjet, or a diastema.

The present disclosure relates to an orthodontic appliance, for use in treating, preventing or ameliorating sleep apnea, teeth grinding, an improperly positioned mandible or maxilla, a prognathic or a retrognathic maxilla or mandible, and/or a malocclusion or condition, wherein optionally the malocclusion or condition include a Class I, Class II or Class III malocclusion, or the malocclusion or condition includes an overbite, underbite (or anterior crossbite), crossbite, overcrowding, spacing problem, open bite, overjet, or a diastema.

The present disclosure also discloses a method of treating, preventing or ameliorating sleep apnea, teeth grinding, an improperly positioned mandible or maxilla, a prognathic or a retrognathic maxilla or mandible, and/or a malocclusion or condition, wherein optionally the malocclusion or condition include a Class I, Class II or Class III malocclusion, or the malocclusion or condition includes an overbite, underbite (or anterior crossbite), crossbite, overcrowding, spacing problem, open bite, overjet, or a diastema, including administering to an individual in need there of orthodontic appliance.

The present disclosure discloses an orthodontic appliance that includes an appliance body having a portion shaped to match a contour of a tooth in an arch, the appliance body configured to couple to the arch to cover about 20% or more and about 99% or less of a surface of the tooth.

The present disclosure relates to an orthodontic appliance, wherein the arch is a mandibular arch or a maxillary arch.

The present disclosure relates to an orthodontic appliance, wherein the appliance body is configured to cover only a portion of an occlusal surface on the tooth or an anterior occlusal surface on the tooth.

The present disclosure relates to an orthodontic appliance, wherein the appliance body is configured to cover up to 99% of an occlusal surface on the tooth or 99% of an anterior occlusal surface on the tooth.

The present disclosure relates to an orthodontic appliance, wherein the appliance body has an opening to allow a tooth to tooth contact on an anterior occlusal surface through the opening.

The present disclosure relates to an orthodontic appliance, wherein the appliance body is configured to cover only a portion of an incisor surface, a canine surface, a posterior occlusal surface, or any combination thereof.

The present disclosure relates to an orthodontic appliance, wherein the appliance body is configured to cover only a portion of a molar surface or a premolar surface.

The present disclosure relates to an orthodontic appliance, wherein the appliance body is configured to cover a plurality of teeth.

The present disclosure relates to an orthodontic appliance, wherein the appliance body is configured to perform palatal expansion or maxillary expansion.

The present disclosure relates to an orthodontic appliance, wherein the appliance body is configured to be coupled to a bone using a bone wire, a bone screw, a bone pin, or any combination thereof.

The present disclosure relates to an orthodontic appliance, the appliance body has a thickness of from about 0.5 mm to about 5 mm.

The present disclosure relates to an orthodontic appliance, further including: a clasp, a wire, a bar, or any combination thereof; or a strap, an affixed sleeve, a removable sleeve, a strap, an anterior hinge, a short or long Herbst, a jack screw, a Herbst hinge, or any combination thereof.

The present disclosure relates to an orthodontic appliance, further including a sensor, a light emitting device, or any combination thereof.

The present disclosure relates to an orthodontic appliance, further including a compliance chip, an electronic or microelectronic device, an electronic accessory to obtain data and communicates the data with another electronic device, or any combination thereof.

The present disclosure relates to a method for making an orthodontic appliance, the method including: (a) importing into a computer aided design (CAD) computer program a digitized data set obtained from a three-dimensional scan of dentition to generate a three-dimensional electronic model of the dentition; (b) inputting data to define dimensions of an orthodontic appliance to be made based on the three-dimensional scan and a shape of the orthodontic appliance, wherein the shape is defined by an effect of the orthodontic appliance on the dentition, a mandibular or maxillary structure, or an alignment of the dentition; (c) subtracting the three-dimensional electronic model of the dentition, and preserving the defined dimensions of the orthodontic appliance, from an image of a virtual solid block or material to obtain an appliance data set; and (d) fabricating the orthodontic appliance from a solid block or material based on the appliance data set, wherein the fabricated orthodontic appliance has a pre-defined thickness.

The present disclosure relates to a method, wherein the manufacturing of the orthodontic appliance includes an additive manufacturing method.

The present disclosure relates to a method, wherein the manufacturing of the orthodontic appliance includes a fused deposit molding (FDM) additive manufacturing process, 3-dimensional printing, injection molding, or any combination thereof.

The present disclosure relates to a method, wherein the orthodontic appliance is configured to cover only a portion of an occlusal surface on a tooth.

The present disclosure relates to a method, wherein the orthodontic appliance is configured to cover up to 99% of an occlusal surface on a tooth.

The present disclosure relates to a kit including at least one orthodontic appliance including an appliance body including a portion shaped to match a contour of a tooth in an arch, the appliance body configured to couple to the arch to cover about 20% or more and about 99% or less of a surface of the tooth.

In some embodiments, provided are products of manufacture that act as precision orthodontic devices or appliances, and kits containing them.

In some embodiments, provided are precision orthodontic devices or appliances having pre-defined thickness or thicknesses. In some embodiments, orthodontic devices or appliances can be made by a process comprising importing into a computer aided design (CAD) computer program a digitized data set obtained from a three-dimensional scan of a patient's dentition for preparing a three-dimensional electronic model of the patient's dentition, inputting data to define the dimensions of a desired orthodontic device or appliance based on the three-dimensional scan of a patient's dentition and the desired shape of the orthodontic device or appliance, which is defined by the desired effect of the orthodontic device or appliance on the patient's dentition and/or mandibular and/or maxillary structure or alignment, subtracting the three-dimensional electronic model of the patient's dentition, and preserving defined dimensions of the desired orthodontic device or appliance, from an image of a solid block or material to obtain an appliance data set, manufacturing a dental appliance from a solid block or material in accordance with the appliance data set. In some embodiments, the fabricated precision orthodontic devices or appliances have a pre-defined thickness or thicknesses. In some embodiments, the present disclosure relates to a precision orthodontic device or appliance having a pre-defined thickness or thicknesses, wherein the precision orthodontic device or appliance is fabricated or manufactured to cover all or a portion of (optionally 1% to 99% of) the surface of one or more or all teeth in an arch. In some embodiments, the arch can be a mandibular (lower) arch or a maxillary (upper) arch.

The present disclosure relates to an orthodontic appliance including an appliance body having a thicknesses to cover 99% or less of a surface of a tooth in an arch. The present disclosure relates to an orthodontic appliance comprising an appliance body to couple to an arch to cover about 99% or less of a surface of a tooth in the arch. In some embodiments, the appliance body is to cover about 95% or less of a surface of a tooth in an arch. In some embodiments, the appliance body is configured to cover about 90% or less of a surface of a tooth in an arch. In some embodiments, the appliance body is configured to cover about 85% or less of a surface of a tooth in an arch. In some embodiments, the appliance body is configured to cover about 80% or less of a surface of a tooth in an arch. In some embodiments, the appliance body is configured to cover about 70% or less of a surface of a tooth in an arch. In some embodiments, the appliance body is configured to cover about 65% or less of a surface of a tooth in an arch. In some embodiments, the appliance body is configured to cover about 60% or less of a surface of a tooth in an arch. In some embodiments, the appliance body is configured to cover about 55% or less of a surface of a tooth in an arch. In some embodiments, the appliance body is configured to cover about 50% or less of a surface of a tooth in an arch. In some embodiments, the appliance body is configured to cover about 45% or less of a surface of a tooth in an arch. In some embodiments, the appliance body is configured to cover about 40% or less of a surface of a tooth in an arch. In some embodiments, the appliance body is configured to cover about 30% or less of a surface of a tooth in an arch. In some embodiments, the appliance body is configured to cover about 20% or less of a surface of a tooth in an arch. In some embodiments, the appliance body is configured to cover about 10% or less of a surface of a tooth in an arch. In some embodiments, the appliance body is configured to cover about 5% or less of a surface of a tooth in an arch.

In some embodiments, the appliance body is configured to cover up to about 1% of a surface of a tooth in an arch. In some embodiments, the appliance body is configured to cover up to about 5% of a surface of a tooth in an arch. In some embodiments, the appliance body is configured to cover up to about 10% of a surface of a tooth in an arch. In some embodiments, the appliance body is configured to cover up to about 15% of a surface of a tooth in an arch. In some embodiments, the appliance body is configured to cover up to about 18% of a surface of a tooth in an arch. In some embodiments, the appliance body is configured to cover up to about 20% of a surface of a tooth in an arch. In some embodiments, the appliance body is configured to cover up to about 25% of a surface of a tooth in an arch. In some embodiments, the appliance body is configured to cover up to about 30% of a surface of a tooth in an arch. In some embodiments, the appliance body is configured to cover up to about 35% of a surface of a tooth in an arch. In some embodiments, the appliance body is configured to cover up to about 40% of a surface of a tooth in an arch. In some embodiments, the appliance body is configured to cover up to about 45% of a surface of a tooth in an arch. In some embodiments, the appliance body is configured to cover up to about 50% of a surface of a tooth in an arch. In some embodiments, the appliance body is configured to cover up to about 55% of a surface of a tooth in an arch. In some embodiments, the appliance body is configured to cover up to about 60% of a surface of a tooth in an arch. In some embodiments, the appliance body is configured to cover up to about 65% of a surface of a tooth in an arch. In some embodiments, the appliance body is configured to cover up to about 70% of a surface of a tooth in an arch. In some embodiments, the appliance body is configured to cover up to about 75% of a surface of a tooth in an arch. In some embodiments, the appliance body is configured to cover up to about 80% of a surface of a tooth in an arch. In some embodiments, the appliance body is configured to cover up to about 85% of a surface of a tooth in an arch. In some embodiments, the appliance body is configured to cover up to about 90% of a surface of a tooth in an arch. In some embodiments, the appliance body is configured to cover up to about 92% of a surface of a tooth in an arch. In some embodiments, the appliance body is configured to cover up to about 95% of a surface of a tooth in an arch. In some embodiments, the appliance body is configured to cover up to about 98% of a surface of a tooth in an arch. In some embodiments, the appliance body is configured to cover up to about 99% of a surface of a tooth in an arch. In some embodiments, the appliance body is configured to cover up to about 99.5% or more of a surface of a tooth in an arch.

In some embodiments, the appliance body is configured to cover from about 1% to about 99% or more of a surface of a tooth in an arch. In some embodiments, the appliance body is configured to cover from about 5% to about 99% of a surface of a tooth in an arch. In some embodiments, the appliance body is configured to cover from about 10% to about 99% of a surface of a tooth in an arch. In some embodiments, the appliance body is configured to cover from about 20% to about 99% of a surface of a tooth in an arch. In some embodiments, the appliance body is configured to cover from about 25% to about 90% of a surface of a tooth in an arch. In some embodiments, the appliance body is configured to cover from about 25% to about 85% of a surface of a tooth in an arch. In some embodiments, the appliance body is configured to cover from about 30% to about 80% of a surface of a tooth in an arch. In some embodiments, the appliance body is configured to cover from about 35% to about 75% of a surface of a tooth in an arch. In some embodiments, the appliance body is configured to cover from about 35% to about 70% of a surface of a tooth in an arch. In some embodiments, the appliance body is configured to cover from about 50% to about 90% of a surface of a tooth in an arch. In some embodiments, the appliance body is configured to cover from about 40% to about 80% of a surface of a tooth in an arch. In some embodiments, the appliance body is configured to cover from about 30% to about 99% of a surface of a tooth in an arch. In some embodiments, the appliance body is configured to cover from about 40% to about 99% of a surface of a tooth in an arch.

The present disclosure relates to an orthodontic appliance including an appliance body having a thicknesses so as to cover 99% or less of a surface of dentition in an arch. The present disclosure relates to an orthodontic appliance comprising an appliance body to couple to an arch to cover about 99% or less of a surface of a tooth in the arch. In some embodiments, the appliance body is configured to cover about 95% or less of a surface of dentition in an arch. In some embodiments, the appliance body is configured to cover about 90% or less of a surface of dentition in an arch. In some embodiments, the appliance body is configured to cover about 85% or less of a surface of dentition in an arch. In some embodiments, the appliance body is configured to cover about 90% or less of a surface of dentition in an arch. In some embodiments, the appliance body is configured to cover about 85% or less of a surface of dentition in an arch. In some embodiments, the appliance body is configured to cover about 80% or less of a surface of dentition in an arch. In some embodiments, the appliance body is configured to cover about 70% or less of a surface of dentition in an arch. In some embodiments, the appliance body is configured to cover about 65% or less of a surface of dentition in an arch. In some embodiments, the appliance body is configured to cover about 60% or less of a surface of dentition in an arch. In some embodiments, the appliance body is configured to cover about 55% or less of a surface of dentition in an arch. In some embodiments, the appliance body is configured to cover about 50% or less of a surface of dentition in an arch. In some embodiments, the appliance body is configured to cover about 45% or less of a surface of dentition in an arch. In some embodiments, the appliance body is configured to cover about 40% or less of a surface of dentition in an arch. In some embodiments, the appliance body is configured to cover about 30% or less of a surface of dentition in an arch. In some embodiments, the appliance body is configured to cover about 25% or less of a surface of dentition in an arch. In some embodiments, the appliance body is configured to cover about 20% or less of a surface of dentition in an arch. In some embodiments, the appliance body is configured to cover about 15% or less of a surface of dentition in an arch. In some embodiments, the appliance body is configured to cover about 10% or less of a surface of dentition in an arch. In some embodiments, the appliance body is configured to cover about 5% or less of a surface of dentition in an arch.

In some embodiments, the appliance body is configured to cover up to about 5% of a surface of dentition in an arch. In some embodiments, the appliance body is configured to cover up to about 10% of a surface of dentition in an arch. In some embodiments, the appliance body is configured to cover up to about 15% of a surface of dentition in an arch. In some embodiments, the appliance body is configured to cover up to about 20% of a surface of dentition in an arch. In some embodiments, the appliance body is configured to cover up to about 25% of a surface of dentition in an arch. In some embodiments, the appliance body is configured to cover up to about 30% of a surface of dentition in an arch. In some embodiments, the appliance body is configured to cover up to about 35% of a surface of dentition in an arch. In some embodiments, the appliance body is configured to cover up to about 40% of a surface of dentition in an arch. In some embodiments, the appliance body is configured to cover up to about 45% of a surface of dentition in an arch. In some embodiments, the appliance body is configured to cover up to about 50% of a surface of dentition in an arch. In some embodiments, the appliance body is configured to cover up to about 55% of a surface of dentition in an arch. In some embodiments, the appliance body is configured to cover up to about 60% of a surface of dentition in an arch. In some embodiments, the appliance body is configured to cover up to about 65% of a surface of dentition in an arch. In some embodiments, the appliance body is configured to cover up to about 70% of a surface of dentition in an arch. In some embodiments, the appliance body is configured to cover up to about 75% of a surface of dentition in an arch. In some embodiments, the appliance body is configured to cover up to about 80% of a surface of dentition in an arch. In some embodiments, the appliance body is configured to cover up to about 85% of a surface of dentition in an arch. In some embodiments, the appliance body is configured to cover up to about 90% of a surface of dentition in an arch. In some embodiments, the appliance body is configured to cover up to about 92% of a surface of dentition in an arch. In some embodiments, the appliance body is configured to cover up to about 95% of a surface of dentition in an arch. In some embodiments, the appliance body is configured to cover up to about 98% of a surface of dentition in an arch. In some embodiments, the appliance body is configured to cover up to about 99% of a surface of dentition in an arch. In some embodiments, the appliance body is configured to cover up to about 99.5% or more of a surface of dentition in an arch.

In some embodiments, the appliance body is configured to cover from about 1% to about 99% of a surface of dentition in an arch. In some embodiments, the appliance body is configured to cover from about 3% to about 99% of a surface of dentition in an arch. In some embodiments, the appliance body is configured to cover from about 5% to about 99% of a surface of dentition in an arch. In some embodiments, the appliance body is configured to cover from about 10% to about 99% of a surface of dentition in an arch. In some embodiments, the appliance body is configured to cover from about 15% to about 99% of a surface of dentition in an arch. In some embodiments, the appliance body is configured to cover from about 20% to about 99% of a surface of dentition in an arch. In some embodiments, the appliance body is configured to cover from about 25% to about 90% of a surface of dentition in an arch. In some embodiments, the appliance body is configured to cover from about 25% to about 85% of a surface of dentition in an arch. In some embodiments, the appliance body is configured to cover from about 30% to about 80% of a surface of dentition in an arch. In some embodiments, the appliance body is configured to cover from about 35% to about 75% of a surface of dentition in an arch. In some embodiments, the appliance body is configured to cover from about 35% to about 70% of a surface of dentition in an arch. In some embodiments, the appliance body is configured to cover from about 50% to about 90% of a surface of dentition in an arch. In some embodiments, the appliance body is configured to cover from about 40% to about 80% of a surface of dentition in an arch. In some embodiments, the appliance body is configured to cover from about 30% to about 99% of a surface of dentition in an arch. In some embodiments, the appliance body is configured to cover from about 40% to about 99% of a surface of dentition in an arch.

In some aspects, the present disclosure relates to a precision orthodontic device or appliance, fabricated or manufactured not to cover, or substantially not cover, one or more or all occlusal surfaces on the teeth, or fabricated or manufactured to cover only a portion of (optionally 1% to 99% of) one or more or all occlusal surfaces on the teeth.

In some aspects, the present disclosure relates to a precision orthodontic device or appliance, wherein the precision orthodontic device or appliance is fabricated or manufactured not cover, or substantially not cover, one or more anterior (optionally incisor or incisor and canine) occlusal surfaces, or to allow tooth to tooth contact on one or more or all anterior (optionally incisor or incisor and canine) occlusal surfaces.

In some aspects, the present disclosure relates to a precision orthodontic device or appliance, wherein the precision orthodontic device or appliance is fabricated or manufactured not to cover, or substantially not cover, one or more anterior (optionally incisor or incisor and canine) occlusal surfaces and posterior (optionally molar and premolar) occlusal surfaces.

In some aspects, the present disclosure relates to a precision orthodontic device or appliance to 4, fabricated or manufactured to cover all teeth in an arch, optionally covering all mandibular (lower) teeth or covering all maxillary (upper) teeth or only a portion of an arch, only a portion of a mandibular (lower) arch or only a portion of a maxillary (upper) arch. In some embodiments, the precision orthodontic device or appliance can be fabricated or manufactured to cover only one, two, three, four, five, six, seven, eight, nine, ten, eleven, twelve, thirteen, fourteen, fifteen or all sixteen teeth in an arch.

In some aspects, the present disclosure relates to a precision orthodontic device or appliance, wherein the precision orthodontic device or appliance is fabricated or manufactured to move one or more teeth, or to stabilize the position of one or more teeth, or is fabricated for mandibular or palatal or maxillary expansion, and optionally the precision orthodontic devices or appliances is fabricated or manufactured to be attached or stabilized directly onto bone, optionally stabilized or attached to bone using one or more bone wires, screws or pins.

In some aspects, the present disclosure relates to a precision orthodontic device or appliance, wherein the fabricated precision orthodontic device or appliance has a pre-defined thickness that is consistent throughout the entire device or appliance; optionally the thickness of the entire device or appliance is designed and fabricated to be between about 0.5 mm and 5 mm, or about 0.5 mm, 1 mm, 1.5 mm, 2 mm, 2.5 mm or 3 mm.

In some aspects, the present disclosure relates to a precision orthodontic device or appliance, wherein the fabricated precision orthodontic device or appliance has a pre-defined but varying thicknesses throughout the entire device or appliance; and optionally the precision orthodontic device or appliance is fabricated or manufacture such that cusp tips or occlusal contact points are pre-defined to have one thickness (optionally, between about 0.2 mm to 2 mm, or 0.5 mm to 1.5 mm), and supporting (or non-occlusal) sections of the device or appliance can have a different, thicker thickness (optionally, between about 2 mm to 2.5 mm or 5 mm), wherein optionally the fabricated precision orthodontic devices or appliances have a pre-defined thickness or thicknesses to be able to apply varying amounts of retentive forces or orthodontic movement forces to the patient's dentition, or to stimulate or generate movement by the mandible or maxilla.

In some aspects, the present disclosure relates to a precision orthodontic device or appliance further including or having incorporated within the body of the precision orthodontic device or appliance any one of the following or any combination of the following: (a) one or more clasps, wires or bars, optionally a metal clasp, wire or bar; (b) a strap, affixed sleeve, removable sleeve, straps, anterior hinge, short or long Herbst, jack screw, or Herbst hinge in combination with jack screw; (c) a sensor or a light emitting device, optionally at least one or more sensors, optionally the sensor is a flexible sensor or an inflexible sensor, and optionally the sensor is a light detection device; or (d) a compliance chip, or an electronic or microelectronic device, or a “smart” accessory (optionally, an electronic device that obtains data and communicates the data with another electronic device).

In some aspects, the present disclosure relates to a precision orthodontic device or appliance, wherein the orthodontic device or appliance is made or fabricated from a composition or material including: poly(butylene succinate) and copolymers thereof; polymethyl-methacrylate (PMMA); lined PMMA; high-strength polyether ether ketone (PEEK); a (meth)acryloyloxy-substituted benzoic acid ester; urethane di(meth)acrylate (UDMA); tricthyleneglycol dimethacrylate (TEGDMA); tetraethylene glycol diacrylate (E4-A); trimethylolpropanetriacrylate (TTA); a polymer matrix including diurethanedimethacrylate (DUDMA) and glycerol dimethacrylate (GDMA); a polymer produced from polyoxymethylene and acetal copolymers (DURACETAL®); glycol modified polyethylene terephthalate (PETg); a physiologically compatible, water insoluble, non-malleable polymer; wood; plastic, and/or, a metal.

In some aspects, the present disclosure relates to a precision orthodontic device or appliance made by a process including importing into a computer aided design (CAD) computer program a digitized data set obtained from a three-dimensional scan of a patient's dentition for preparing a three-dimensional electronic model of the patient's dentition, inputting data to define the dimensions of a desired orthodontic device or appliance based on the three-dimensional scan of a patient's dentition and the desired shape of the orthodontic device or appliance, which is defined by the desired effect of the orthodontic device or appliance on the patient's dentition and/or mandibular and/or maxillary structure or alignment, subtracting the three-dimensional electronic model of the patient's dentition, and preserving defined dimensions of the desired orthodontic device or appliance, from an image of a virtual solid block or material to obtain an appliance data set, and manufacturing the precision orthodontic device or appliance from a solid block or material in accordance with the appliance data set, wherein the fabricated precision orthodontic device or appliance has a pre-defined thickness or thicknesses.

In some aspects, the present disclosure relates to a precision orthodontic device or appliance, wherein the manufacturing of the dental appliance includes additive manufacturing methods. In some embodiments, the manufacturing of the dental appliance includes a fused deposit molding (FDM) additive manufacturing process; 3-dimensional printing; and/or, injection molding; and/or, including subtractive manufacturing processes, optionally including carving and/or milling.

In some aspects, the present disclosure relates to a precision orthodontic device or appliance that can be fabricated or manufactured not to cover, or substantially not cover, one or more or all occlusal surfaces on the teeth, or fabricated or manufactured to cover only a portion of (optionally 1% to 99% of) one or more or all occlusal surfaces on the teeth.

The present disclosure relates to an orthodontic appliance including an appliance body having a thicknesses to cover 99% or less of a surface of a tooth in an arch. The present disclosure relates to an orthodontic appliance comprising an appliance body to couple to an arch to cover about 99% or less of a surface of a tooth in the arch. In some embodiments, the appliance body is configured to cover about 95% or less of a surface of a tooth in an arch. In some embodiments, the appliance body is configured to cover about 90% or less of a surface of a tooth in an arch. In some embodiments, the appliance body is configured to cover about 85% or less of a surface of a tooth in an arch. In some embodiments, the appliance body is configured to cover about 90% or less of a surface of a tooth in an arch. In some embodiments, the appliance body is configured to cover about 85% or less of a surface of a tooth in an arch. In some embodiments, the appliance body is configured to cover about 80% or less of a surface of a tooth in an arch. In some embodiments, the appliance body is configured to cover about 70% or less of a surface of a tooth in an arch. In some embodiments, the appliance body is configured to cover about 65% or less of a surface of a tooth in an arch. In some embodiments, the appliance body is configured to cover about 60% or less of a surface of a tooth in an arch. In some embodiments, the appliance body is configured to cover about 55% or less of a surface of a tooth in an arch. In some embodiments, the appliance body is configured to cover about 50% or less of a surface of a tooth in an arch. In some embodiments, the appliance body is configured to cover about 45% or less of a surface of a tooth in an arch. In some embodiments, the appliance body is configured to cover about 40% or less of a surface of a tooth in an arch. In some embodiments, the appliance body is configured to cover about 30% or less of a surface of a tooth in an arch. In some embodiments, the appliance body is configured to cover about 20% or less of a surface of a tooth in an arch. In some embodiments, the appliance body is configured to cover about 10% or less of a surface of a tooth in an arch. In some embodiments, the appliance body is configured to cover about 5% or less of a surface of a tooth in an arch.

In some embodiments, the appliance body is configured to cover up to about 1% of a surface of a tooth in an arch. In some embodiments, the appliance body is configured to cover up to about 5% of a surface of a tooth in an arch. In some embodiments, the appliance body is configured to cover up to about 10% of a surface of a tooth in an arch. In some embodiments, the appliance body is configured to cover up to about 15% of a surface of a tooth in an arch. In some embodiments, the appliance body is configured to cover up to about 18% of a surface of a tooth in an arch. In some embodiments, the appliance body is configured to cover up to about 20% of a surface of a tooth in an arch. In some embodiments, the appliance body is configured to cover up to about 25% of a surface of a tooth in an arch. In some embodiments, the appliance body is configured to cover up to about 30% of a surface of a tooth in an arch. In some embodiments, the appliance body is configured to cover up to about 35% of a surface of a tooth in an arch. In some embodiments, the appliance body is configured to cover up to about 40% of a surface of a tooth in an arch. In some embodiments, the appliance body is configured to cover up to about 45% of a surface of a tooth in an arch. In some embodiments, the appliance body is configured to cover up to about 50% of a surface of a tooth in an arch. In some embodiments, the appliance body is configured to cover up to about 55% of a surface of a tooth in an arch. In some embodiments, the appliance body is configured to cover up to about 60% of a surface of a tooth in an arch. In some embodiments, the appliance body is configured to cover up to about 65% of a surface of a tooth in an arch. In some embodiments, the appliance body is configured to cover up to about 70% of a surface of a tooth in an arch. In some embodiments, the appliance body is configured to cover up to about 75% of a surface of a tooth in an arch. In some embodiments, the appliance body is configured to cover up to about 80% of a surface of a tooth in an arch. In some embodiments, the appliance body is configured to cover up to about 85% of a surface of a tooth in an arch. In some embodiments, the appliance body is configured to cover up to about 90% of a surface of a tooth in an arch. In some embodiments, the appliance body is configured to cover up to about 92% of a surface of a tooth in an arch. In some embodiments, the appliance body is configured to cover up to about 95% of a surface of a tooth in an arch. In some embodiments, the appliance body is configured to cover up to about 98% of a surface of a tooth in an arch. In some embodiments, the appliance body is configured to cover up to about 99% of a surface of a tooth in an arch. In some embodiments, the appliance body is configured to cover up to about 99.5% or more of a surface of a tooth in an arch.

In some embodiments, the appliance body is configured to cover from about 1% to about 99% of a surface of a tooth in an arch. In some embodiments, the appliance body is configured to cover from about 5% to about 99% of a surface of a tooth in an arch. In some embodiments, the appliance body is configured to cover from about 10% to about 99% of a surface of a tooth in an arch. In some embodiments, the appliance body is configured to cover from about 20% to about 99% of a surface of a tooth in an arch. In some embodiments, the appliance body is configured to cover from about 25% to about 90% of a surface of a tooth in an arch. In some embodiments, the appliance body is configured to cover from about 25% to about 85% of a surface of a tooth in an arch. In some embodiments, the appliance body is configured to cover from about 30% to about 80% of a surface of a tooth in an arch. In some embodiments, the appliance body is configured to cover from about 35% to about 75% of a surface of a tooth in an arch. In some embodiments, the appliance body is configured to cover from about 35% to about 70% of a surface of a tooth in an arch. In some embodiments, the appliance body is configured to cover from about 50% to about 90% of a surface of a tooth in an arch. In some embodiments, the appliance body is configured to cover from about 40% to about 80% of a surface of a tooth in an arch. In some embodiments, the appliance body is configured to cover from about 30% to about 99% of a surface of a tooth in an arch. In some embodiments, the appliance body is configured to cover from about 40% to about 99% of a surface of a tooth in an arch.

The present disclosure relates to an orthodontic appliance including an appliance body having a thicknesses to cover 99% or less of a surface of dentition in an arch. The present disclosure relates to an orthodontic appliance comprising an appliance body to couple to an arch to cover about 99% or less of a surface of a tooth in the arch. In some embodiments, the appliance body is configured to cover about 95% or less of a surface of dentition in an arch. In some embodiments, the appliance body is configured to cover about 90% or less of a surface of dentition in an arch. In some embodiments, the appliance body is configured to cover about 85% or less of a surface of dentition in an arch. In some embodiments, the appliance body is configured to cover about 90% or less of a surface of dentition in an arch. In some embodiments, the appliance body is configured to cover about 85% or less of a surface of dentition in an arch. In some embodiments, the appliance body is configured to cover about 80% or less of a surface of dentition in an arch. In some embodiments, the appliance body is configured to cover about 70% or less of a surface of dentition in an arch. In some embodiments, the appliance body is configured to cover about 65% or less of a surface of dentition in an arch. In some embodiments, the appliance body is configured to cover about 60% or less of a surface of dentition in an arch. In some embodiments, the appliance body is configured to cover about 55% or less of a surface of dentition in an arch. In some embodiments, the appliance body is configured to cover about 50% or less of a surface of dentition in an arch. In some embodiments, the appliance body is configured to cover about 45% or less of a surface of dentition in an arch. In some embodiments, the appliance body is configured to cover about 40% or less of a surface of dentition in an arch. In some embodiments, the appliance body is configured to cover about 30% or less of a surface of dentition in an arch. In some embodiments, the appliance body is configured to cover about 25% or less of a surface of dentition in an arch. In some embodiments, the appliance body is configured to cover about 20% or less of a surface of dentition in an arch. In some embodiments, the appliance body is configured to cover about 15% or less of a surface of dentition in an arch. In some embodiments, the appliance body is configured to cover about 10% or less of a surface of dentition in an arch. In some embodiments, the appliance body is configured to cover about 5% or less of a surface of dentition in an arch.

In some embodiments, the appliance body is configured to cover up to about 5% of a surface of dentition in an arch. In some embodiments, the appliance body is configured to cover up to about 10% of a surface of dentition in an arch. In some embodiments, the appliance body is configured to cover up to about 15% of a surface of dentition in an arch. In some embodiments, the appliance body is configured to cover up to about 20% of a surface of dentition in an arch. In some embodiments, the appliance body is configured to cover up to about 25% of a surface of dentition in an arch. In some embodiments, the appliance body is configured to cover up to about 30% of a surface of dentition in an arch. In some embodiments, the appliance body is configured to cover up to about 35% of a surface of dentition in an arch. In some embodiments, the appliance body is configured to cover up to about 40% of a surface of dentition in an arch. In some embodiments, the appliance body is configured to cover up to about 45% of a surface of dentition in an arch. In some embodiments, the appliance body is configured to cover up to about 50% of a surface of dentition in an arch. In some embodiments, the appliance body is configured to cover up to about 55% of a surface of dentition in an arch. In some embodiments, the appliance body is configured to cover up to about 60% of a surface of dentition in an arch. In some embodiments, the appliance body is configured to cover up to about 65% of a surface of dentition in an arch. In some embodiments, the appliance body is configured to cover up to about 70% of a surface of dentition in an arch. In some embodiments, the appliance body is configured to cover up to about 75% of a surface of dentition in an arch. In some embodiments, the appliance body is configured to cover up to about 80% of a surface of dentition in an arch. In some embodiments, the appliance body is configured to cover up to about 85% of a surface of dentition in an arch. In some embodiments, the appliance body is configured to cover up to about 90% of a surface of dentition in an arch. In some embodiments, the appliance body is configured to cover up to about 92% of a surface of dentition in an arch. In some embodiments, the appliance body is configured to cover up to about 95% of a surface of dentition in an arch. In some embodiments, the appliance body is configured to cover up to about 98% of a surface of dentition in an arch. In some embodiments, the appliance body is configured to cover up to about 99% of a surface of dentition in an arch. In some embodiments, the appliance body is configured to cover up to about 99.5% of a surface of dentition in an arch.

In some embodiments, the appliance body is configured to cover from about 1% to about 99% of a surface of dentition in an arch. In some embodiments, the appliance body is configured to cover from about 3% to about 99% of a surface of dentition in an arch. In some embodiments, the appliance body is configured to cover from about 5% to about 99% of a surface of dentition in an arch. In some embodiments, the appliance body is configured to cover from about 10% to about 99% of a surface of dentition in an arch. In some embodiments, the appliance body is configured to cover from about 15% to about 99% of a surface of dentition in an arch. In some embodiments, the appliance body is configured to cover from about 20% to about 99% of a surface of dentition in an arch. In some embodiments, the appliance body is configured to cover from about 25% to about 90% of a surface of dentition in an arch. In some embodiments, the appliance body is configured to cover from about 25% to about 85% of a surface of dentition in an arch. In some embodiments, the appliance body is configured to cover from about 30% to about 80% of a surface of dentition in an arch. In some embodiments, the appliance body is configured to cover from about 35% to about 75% of a surface of dentition in an arch. In some embodiments, the appliance body is configured to cover from about 35% to about 70% of a surface of dentition in an arch. In some embodiments, the appliance body is configured to cover from about 50% to about 90% of a surface of dentition in an arch. In some embodiments, the appliance body is configured to cover from about 40% to about 80% of a surface of dentition in an arch. In some embodiments, the appliance body is configured to cover from about 30% to about 99% of a surface of dentition in an arch. In some embodiments, the appliance body is configured to cover from about 40% to about 99% of a surface of dentition in an arch.

In some aspects, the present disclosure relates to a precision orthodontic device or appliance, wherein the precision orthodontic device or appliance is fabricated or manufactured to move one or more teeth, or to stabilize the position of one or more teeth, or is fabricated for mandibular or maxillary expansion, and optionally the precision orthodontic devices or appliances is fabricated or manufactured to be attached or stabilized directly onto bone, optionally stabilized or attached to bone using one or more bone wires, screws or pins.

In some aspects, the present disclosure relates to a precision orthodontic device or appliance, wherein the precision orthodontic device or appliance is fabricated or manufactured not to cover, or substantially not cover, one or more anterior (optionally incisor or incisor and canine) occlusal surfaces, or to allow tooth to tooth contact on one or more or all anterior (optionally incisor or incisor and canine) occlusal surfaces.

In some aspects, the present disclosure relates to a precision orthodontic device or appliance, wherein the precision orthodontic device or appliance is fabricated or manufactured not to cover, or substantially not cover, one or more anterior (optionally incisor or incisor and canine) occlusal surfaces and posterior (optionally molar and premolar) occlusal surfaces.

In some aspects, the present disclosure relates to a precision orthodontic device or appliance can include or have incorporated within the body of the precision orthodontic device or appliance the following or any combination of the following: (a) one or more clasps, wires or bars, optionally a metal clasp, wire or bar; (b) a strap, affixed sleeve, removable sleeve, straps, anterior hinge, short or long Herbst, jack screw, or Herbst hinge in combination with jack screw; (c) a sensor or a light emitting device, optionally at least one or more sensors, optionally the sensor is a flexible sensor or an inflexible sensor, and optionally the sensor is a light detection device; or (d) a compliance chip, or an electronic or microelectronic device, or a “smart” accessory (optionally, an electronic device that obtains data and communicates the data with another electronic device).

In some aspects, the present disclosure relates to a precision orthodontic device or appliance, wherein the orthodontic device or appliance is made or fabricated from a composition or material including any one or any combination of poly(butylene succinate) and copolymers thereof; polymethyl-methacrylate (PMMA); lined PMMA; high-strength polyether ether ketone (PEEK); a (meth)acryloyloxy-substituted benzoic acid ester; urethane di(meth)acrylate (UDMA); triethyleneglycol dimethacrylate (TEGDMA); tetraethylene glycol diacrylate (E4-A); trimethylolpropanetriacrylate (TTA); a polymer matrix including diurethanedimethacrylate (DUDMA) and glycerol dimethacrylate (GDMA); a polymer produced from polyoxymethylene and acetal copolymers (DURACETAL®); glycol modified polyethylene terephthalate (PETg); a physiologically compatible, water insoluble, non-malleable polymer; wood; plastic, and/or, a metal.

In some aspects, the present disclosure relates to a method for making a precision orthodontic device or appliance including importing into a computer aided design (CAD) computer program a digitized data set obtained from a three-dimensional scan of a patient's dentition for preparing a three-dimensional electronic model of the patient's dentition, inputting data to define the dimensions of a desired orthodontic device or appliance based on the three-dimensional scan of a patient's dentition and the desired shape of the orthodontic device or appliance, which is defined by the desired effect of the orthodontic device or appliance on the patient's dentition and/or mandibular and/or maxillary structure or alignment, subtracting the three-dimensional electronic model of the patient's dentition, and preserving defined dimensions of the desired orthodontic device or appliance, from an image of a virtual solid block or material to obtain an appliance data set, and manufacturing the precision orthodontic device or appliance from a solid block or material in accordance with the appliance data set, wherein the fabricated precision orthodontic device or appliance has a pre-defined thickness or thicknesses.

In some aspects, In some embodiments, the manufacturing of the precision orthodontic device or appliance from a solid block or material includes additive manufacturing methods. In some embodiments, the manufacturing of the orthodontic appliance can include a fused deposit molding (FDM) additive manufacturing process, 3-dimensional printing, and/or, injection molding. In some embodiments, the manufacturing of the orthodontic appliance can include subtractive manufacturing processes, optionally including carving and/or milling.

In some aspects, the present disclosure relates to the precision orthodontic device or appliance fabricated or manufactured not to cover, or substantially not cover, one or more or all occlusal surfaces on the teeth, or is fabricated or manufactured to cover only a portion of (optionally 1% to 99% of) one or more or all occlusal surfaces on the teeth.

In some aspects, the present disclosure relates to the precision orthodontic device or appliance is fabricated or manufactured to move one or more teeth, or to stabilize the position of one or more teeth, or is fabricated for mandibular or maxillary expansion, and optionally the precision orthodontic devices or appliances is fabricated or manufactured to be attached or stabilized directly onto bone, optionally stabilized or attached to bone using one or more bone wires, screws or pins.

In some aspects, the present disclosure relates to the precision orthodontic device or appliance that is fabricated or manufactured not to cover, or substantially not cover, one or more anterior (e.g., incisor or incisor and canine, etc.) occlusal surfaces, or to allow tooth to tooth contact on one or more or all anterior (e.g., incisor or incisor and canine, etc.) occlusal surfaces.

In some aspects, the present disclosure relates to the precision orthodontic device or appliance that is fabricated or manufactured not to cover, or substantially not cover, one or more anterior (e.g., incisor or incisor and canine, etc.) occlusal surfaces and posterior (e.g., molar and premolar, etc.) occlusal surfaces.

In some aspects, the present disclosure relates to the orthodontic device or appliance is made or fabricated from a composition or material including: poly(butylene succinate) and copolymers thereof; polymethyl-methacrylate (PMMA); lined PMMA; high-strength polyether ether ketone (PEEK); a (meth)acryloyloxy-substituted benzoic acid ester; urethane di(meth)acrylate (UDMA); triethyleneglycol dimethacrylate (TEGDMA); tetraethylene glycol diacrylate (E4-A); trimethylolpropanetriacrylate (TTA); a polymer matrix including diurethanedimethacrylate (DUDMA) and glycerol dimethacrylate (GDMA); a polymer produced from polyoxymethylene and acetal copolymers (DURACETAL®); glycol modified polyethylene terephthalate (PETg); a physiologically compatible, water insoluble, non-malleable polymer; wood; plastic, and/or, a metal.

In some aspects, the present disclosure relates to a kit including one, two, three or more precision orthodontic devices or appliances based on the present disclosures.

In some aspects, In some embodiments, the kit includes both a mandibular (lower) arch orthodontic device or appliance and a maxillary (upper) arch orthodontic device or appliance, or a set of upper and lower orthodontic devices or appliances.

In some aspects, In some embodiments, the kit includes two or more mandibular (lower) arch orthodontic devices or appliances, wherein each of the two or more mandibular orthodontic devices or appliances has a different design or shape, and optionally the two or more mandibular orthodontic devices or appliances are designed to be consecutively by the patient for mandibular tooth movement or mandibular or palatal expansion.

In some aspects, In some embodiments, the kit includes two or more maxillary (upper) arch orthodontic devices or appliances, wherein each of the two or more maxillary orthodontic devices or appliances has a different design or shape, and optionally the two or more maxillary orthodontic devices or appliances are designed to be consecutively by the patient for maxillary tooth movement or palatal or maxillary expansion.

In some aspects, the present disclosure relates to use precision orthodontic device or appliance, for treating, preventing or ameliorating sleep apnea, teeth grinding, an improperly positioned mandible or maxilla, a prognathic or a retrognathic maxilla or mandible, and/or a malocclusion or condition, wherein optionally the malocclusion or condition include a Class I, Class II or Class III malocclusion, or the malocclusion or condition includes an overbite, underbite (or anterior crossbite), crossbite, overcrowding, spacing problem, open bite, overjet, or a diastema.

In some aspects, the present disclosure relates to a precision orthodontic device or appliance as set forth in any to 18, for use in treating, preventing or ameliorating sleep apnea, teeth grinding, an improperly positioned mandible or maxilla, a prognathic or a retrognathic maxilla or mandible, and/or a malocclusion or condition, wherein optionally the malocclusion or condition include a Class I, Class II or Class III malocclusion, or the malocclusion or condition includes an overbite, underbite (or anterior crossbite), crossbite, overcrowding, spacing problem, open bite, overjet, or a diastema.

In some aspects, the present disclosure relates to a method treating, preventing or ameliorating sleep apnea, teeth grinding, an improperly positioned mandible or maxilla, a prognathic or a retrognathic maxilla or mandible, and/or a malocclusion or condition, wherein optionally the malocclusion or condition include a Class I, Class II or Class III malocclusion, or the malocclusion or condition includes an overbite, underbite (or anterior crossbite), crossbite, overcrowding, spacing problem, open bite, overjet, or a diastema, including administering to an individual in need there 1 to 18.

In some embodiments, provided are methods or processes for making these precision orthodontic devices or appliances. In some embodiments, the precision orthodontic devices or appliances provided herein are made by additive manufacturing methods such as 3-dimensional printing; and in some embodiments, orthodontic devices provided herein are made by subtractive manufacturing processes such as carving and milling.

In some embodiments, orthodontic devices or appliances, and kits for packaging them and providing them to a user, for example, to a dentist or directly to a patient are disclosed.

In some embodiments, orthodontic devices or appliances having a pre-defined thickness or thicknesses, wherein the precision orthodontic device or appliance is fabricated or manufactured to cover all or a portion of (optionally 1% to 99% of) the surface of one or more or all teeth in an arch, and optionally the arch is a mandibular (lower) arch or a maxillary (upper) arch are disclosed.

In some embodiments, an orthodontic device or appliance can be fabricated or manufactured not to cover (such that it does not cover or mask), or substantially does not cover, one or more or all occlusal surfaces on the teeth, or fabricated or manufactured to cover only a portion of (optionally 1% to 99% of) one or more or all occlusal surfaces on the teeth.

In some embodiments, an orthodontic device or appliance is fabricated or manufactured not to cover, or substantially does not cover, one or more anterior (optionally incisor or incisor and canine) occlusal surfaces, or to allow tooth to tooth contact on one or more or all anterior (optionally incisor or incisor and canine) occlusal surfaces.

In some embodiments, an orthodontic device or appliance is fabricated or manufactured not to cover, or substantially does not cover, one or more anterior (optionally incisor or incisor and canine) occlusal surfaces and posterior (optionally molar and premolar) occlusal surfaces.

In some embodiments, an orthodontic device or appliance is fabricated or manufactured to cover or substantially cover all teeth in an arch, optionally covering all mandibular (lower) teeth or covering all maxillary (upper) teeth.

In some embodiments, an orthodontic device or appliance is fabricated or manufactured to cover or substantially cover only a portion of an arch, optionally only a portion of a mandibular (lower) arch or only a portion of a maxillary (upper) arch. In some embodiments, the precision orthodontic device or appliance is fabricated or manufactured to cover only one, two, three, four, five, six, seven, eight, nine, ten, eleven, twelve, thirteen, fourteen, fifteen or all sixteen teeth in an arch;

In some embodiments, an orthodontic device or appliance is fabricated or manufactured to move one or more teeth, or to stabilize the position of one or more teeth, or is fabricated for mandibular or palatal or maxillary expansion, and optionally the precision orthodontic devices or appliances is fabricated or manufactured to be attached or stabilized directly onto bone, optionally stabilized or attached to bone using one or more bone wires, screws or pins.

In some embodiments, an orthodontic device or appliance has a pre-defined thickness that is consistent throughout the entire device or appliance; optionally the thickness of the entire device or appliance is designed and fabricated to be between about 0.5 mm and 5 mm, or about 0.5 mm, 1 mm, 1.5 mm, 2 mm, 2.5 mm or 3 mm.

In some embodiments, an orthodontic device or appliance has a pre-defined but varying thicknesses throughout the entire device or appliance; and optionally the precision orthodontic device or appliance is fabricated or manufacture such that cusp tips or occlusal contact points are pre-defined to have one thickness (optionally, between about 0.2 mm to 2 mm, or 0.5 mm to 1.5 mm), and supporting (or non-occlusal) sections of the device or appliance can have a different, thicker thickness (optionally, between about 2 mm to 2.5 mm or 5 mm), In some embodiments, an orthodontic device or appliance has a pre-defined thickness or thicknesses to be able to apply varying amounts of retentive forces or orthodontic movement forces to the patient's dentition, or to stimulate or generate movement by the mandible or maxilla.

In some embodiments, an orthodontic device or appliance may further comprise or has incorporated within the body of the precision orthodontic device or appliance one or more clasps, wires or bars, optionally a metal clasp, wire or bar.

In some embodiments, an orthodontic device or appliance may further comprise or has incorporated within the body of the precision orthodontic device or appliance a strap, affixed sleeve, removable sleeve, straps, anterior hinge, short or long Herbst, jack screw, or Herbst hinge in combination with jack screw.

In some embodiments, an orthodontic device or appliance may further comprise or has incorporated within the body of the precision orthodontic device or appliance a sensor or a light emitting device, optionally at least one or more sensors, optionally the sensor is a flexible sensor or an inflexible sensor, and optionally the sensor is a light detection device.

In some embodiments, an orthodontic device or appliance may further comprise or has incorporated within the body of the precision orthodontic device or appliance a compliance chip, or an electronic or microelectronic device, or a “smart” accessory (optionally, an electronic device that obtains data and communicates the data with another electronic device).

In some embodiments, an orthodontic device or appliance may include, made or fabricated from a composition or material comprising: poly(butylene succinate) and copolymers thereof; polymethyl-methacrylate (PMMA); lined PMMA; high-strength polyether ether ketone (PEEK); a (meth)acryloyloxy-substituted benzoic acid ester; urethane di(meth)acrylate (UDMA); tricthyleneglycol dimethacrylate (TEGDMA); tetraethylene glycol diacrylate (E4-A); trimethylolpropanetriacrylate (TTA); a polymer matrix comprising diurethanedimethacrylate (DUDMA) and glycerol dimethacrylate (GDMA); a polymer produced from polyoxymethylene and acetal copolymers (DURACETAL®); glycol modified polyethylene terephthalate (PETg); a physiologically compatible, water insoluble, non-malleable polymer; wood; plastic, and/or, a metal.

In some embodiments, provided are precision orthodontic devices or appliances made by a process comprising the steps of importing into a computer aided design (CAD) computer program a digitized data set obtained from a three-dimensional scan of a patient's dentition for preparing a three-dimensional electronic model of the patient's dentition, inputting data to define the dimensions of a desired orthodontic device or appliance based on the three-dimensional scan of a patient's dentition and the desired shape of the orthodontic device or appliance, which is defined by the desired effect of the orthodontic device or appliance on the patient's dentition and/or mandibular and/or maxillary structure or alignment, subtracting the three-dimensional electronic model of the patient's dentition, and preserving defined dimensions of the desired orthodontic device or appliance, from an image of a virtual solid block or material to obtain an appliance data set, and manufacturing the precision orthodontic device or appliance from a solid block or material in accordance with the appliance data set, wherein the fabricated precision orthodontic device or appliance has a pre-defined thickness or thicknesses.

In some embodiments, the manufacturing of the orthodontic appliance comprises additive manufacturing methods. In some embodiments, the manufacturing of the orthodontic appliance comprises a fused deposit molding (FDM) additive manufacturing process; 3-dimensional printing; and/or, injection molding; and/or, comprising subtractive manufacturing processes, optionally comprising carving and/or milling.

In some embodiments, the orthodontic appliance is fabricated or manufactured not to cover, or to substantially not cover, one or more or all occlusal surfaces on the teeth, or fabricated or manufactured to cover, or to substantially not cover, only a portion of (optionally 1% to 99% of) one or more or all occlusal surfaces on the teeth.

In some embodiments, the precision orthodontic device or appliance is fabricated or manufactured to move one or more teeth, or to stabilize the position of one or more teeth, or is fabricated for mandibular or maxillary expansion, and optionally the precision orthodontic devices or appliances is fabricated or manufactured to be attached or stabilized directly onto bone, optionally stabilized or attached to bone using one or more bone wires, screws or pins.

In some embodiments, the precision orthodontic device or appliance is fabricated or manufactured not to cover, or to substantially not cover, one or more anterior (optionally incisor or incisor and canine) occlusal surfaces, or to allow tooth to tooth contact, or substantially contact, on one or more or all anterior (optionally incisor or incisor and canine) occlusal surfaces.

In some embodiments, the precision orthodontic device or appliance is fabricated or manufactured not to cover, or to substantially not cover, one or more anterior (optionally incisor or incisor and canine) occlusal surfaces and posterior (optionally molar and premolar) occlusal surfaces. In some embodiments, the precision orthodontic device or appliance further comprises or has incorporated within the body of the precision orthodontic device or appliance one or more clasps, wires or bars, optionally a metal clasp, wire or bar. In some embodiments, the precision orthodontic device or appliance further comprises or has incorporated within the body of the precision orthodontic device or appliance a strap, affixed sleeve, removable sleeve, straps, anterior hinge, short or long Herbst, jack screw, or Herbst hinge in combination with jack screw. In some embodiments, the precision orthodontic device or appliance further comprises or has incorporated within the body of the precision orthodontic device or appliance a sensor or a light emitting device, optionally at least one or more sensors, optionally the sensor is a flexible sensor or an inflexible sensor, and optionally the sensor is a light detection device. In some embodiments, the precision orthodontic device or appliance further comprises or has incorporated within the body of the precision orthodontic device or appliance a compliance chip, or an electronic or microelectronic device, or a “smart” accessory (optionally, an electronic device that obtains data and communicates the data with another electronic device).

In some embodiments, the precision orthodontic device or appliance as provided herein is made or fabricated from a composition or material comprising: poly(butylene succinate) and copolymers thereof; polymethyl-methacrylate (PMMA); lined PMMA; high-strength polyether ether ketone (PEEK); a (meth)acryloyloxy-substituted benzoic acid ester; urethane di(meth)acrylate (UDMA); tricthyleneglycol dimethacrylate (TEGDMA); tetraethylene glycol diacrylate (E4-A); trimethylolpropanetriacrylate (TTA); a polymer matrix comprising diurethanedimethacrylate (DUDMA) and glycerol dimethacrylate (GDMA); a polymer produced from polyoxymethylene and acetal copolymers (DURACETAL®); glycol modified polyethylene terephthalate (PETg); a physiologically compatible, water insoluble, non-malleable polymer; wood; plastic, and/or, a metal.

In some embodiments, provided are methods for making a precision orthodontic device or appliance may comprise importing into a computer aided design (CAD) computer program a digitized data set obtained from a three-dimensional scan of a patient's dentition for preparing a three-dimensional electronic model of the patient's dentition, inputting data to define the dimensions of a desired orthodontic device or appliance based on the three-dimensional scan of a patient's dentition and the desired shape of the orthodontic device or appliance, which is defined by the desired effect of the orthodontic device or appliance on the patient's dentition and/or mandibular and/or maxillary structure or alignment, subtracting the three-dimensional electronic model of the patient's dentition, and preserving defined dimensions of the desired orthodontic device or appliance, from an image of a virtual solid block or material to obtain an appliance data set, and manufacturing the precision orthodontic device or appliance from a solid block or material in accordance with the appliance data set, wherein the fabricated precision orthodontic device or appliance has a pre-defined thickness or thicknesses.

In some embodiments, the manufacturing of the precision orthodontic device or appliance from a solid block or material may comprises additive manufacturing methods. n some embodiments, the manufacturing of the precision orthodontic device or appliance from a solid block or material may comprises a fused deposit molding (FDM) additive manufacturing process, 3-dimensional printing, injection molding, and a combination thereof. n some embodiments, the manufacturing of the precision orthodontic device or appliance from a solid block or material may comprises subtractive manufacturing processes, optionally comprising carving and/or milling.

In some embodiments, the precision orthodontic device or appliance can be fabricated or manufactured not cover one or more or all occlusal surfaces on the teeth, or can be fabricated or manufactured to cover only a portion of (optionally 1% to 99% of) one or more or all occlusal surfaces on the teeth.

In some embodiments, the precision orthodontic device or appliance is fabricated or manufactured to move one or more teeth, or to stabilize the position of one or more teeth, or is fabricated for mandibular or maxillary expansion. In some embodiments, the precision orthodontic devices or appliances is fabricated or manufactured to be attached or stabilized directly onto bone, optionally stabilized or attached to bone using one or more bone wires, screws or pins.

In some embodiments, the precision orthodontic device or appliance is fabricated or manufactured not cover one or more anterior (optionally incisor or incisor and canine) occlusal surfaces, or to allow tooth to tooth contact on one or more or all anterior (optionally incisor or incisor and canine) occlusal surfaces;

In some embodiments, the precision orthodontic device or appliance is fabricated or manufactured not cover one or more anterior (optionally incisor or incisor and canine) occlusal surfaces and posterior (optionally molar and premolar) occlusal surfaces.

In some embodiments, the orthodontic device or appliance is made or fabricated from a composition or material comprising: poly(butylene succinate) and copolymers thereof; polymethyl-methacrylate (PMMA); lined PMMA; high-strength polyether ether ketone (PEEK); a (meth)acryloyloxy-substituted benzoic acid ester; urethane di(meth)acrylate (UDMA); triethyleneglycol dimethacrylate (TEGDMA); tetraethylene glycol diacrylate (E4-A); trimethylolpropanetriacrylate (TTA); a polymer matrix comprising diurethanedimethacrylate (DUDMA) and glycerol dimethacrylate (GDMA); a polymer produced from polyoxymethylene and acetal copolymers (DURACETAL®); glycol modified polyethylene terephthalate (PETg); a physiologically compatible, water insoluble, non-malleable polymer; wood; plastic, and/or, a metal.

In some embodiments, kits, sets or packages comprising one, two, three or more precision orthodontic devices or appliances as provided herein are provided.

In some embodiments, kits, sets or packages are provided.

In some embodiments, the kit, set or package comprises both a mandibular (lower) arch orthodontic device or appliance and a maxillary (upper) arch orthodontic device or appliance, or a set of upper and lower orthodontic devices or appliances. In some embodiments, the kit, set or package comprises two or more mandibular (lower) arch orthodontic devices or appliances, wherein each of the two or more mandibular orthodontic devices or appliances has a different design or shape, and optionally the two or more mandibular orthodontic devices or appliances are designed to be consecutively by the patient for mandibular tooth movement or mandibular or palatal expansion.

In some embodiments, the kit, set or package comprises two or more maxillary (upper) arch orthodontic devices or appliances, wherein each of the two or more maxillary orthodontic devices or appliances has a different design or shape, and optionally the two or more maxillary orthodontic devices or appliances are designed to be consecutively by the patient for maxillary tooth movement or palatal or maxillary expansion.

In some embodiments provided are uses of a precision orthodontic device or appliance as provided herein for treating, preventing or ameliorating sleep apnea, teeth grinding, an improperly positioned mandible or maxilla, a prognathic or a retrognathic maxilla or mandible, and/or a malocclusion or condition, wherein optionally the malocclusion or condition comprise a Class I, Class II or Class III malocclusion, or the malocclusion or condition comprises an overbite, underbite (or anterior crossbite), crossbite, overcrowding, spacing problem, open bite, overjet, or a diastema.

In some embodiments provided are precision orthodontic devices or appliances, wherein the precision orthodontic devices or appliances are as described herein or made using a method as described herein, for use in treating, preventing or ameliorating sleep apnea, teeth grinding, an improperly positioned mandible or maxilla, a prognathic or a retrognathic maxilla or mandible, and/or a malocclusion or condition, wherein optionally the malocclusion or condition comprise a Class I, Class II or Class III malocclusion, or the malocclusion or condition comprises an overbite, underbite (or anterior crossbite), crossbite, overcrowding, spacing problem, open bite, overjet, or a diastema.

In some embodiments provided are methods treating, preventing or ameliorating sleep apnea, teeth grinding, an improperly positioned mandible or maxilla, a prognathic or a retrognathic maxilla or mandible, and/or a malocclusion or condition, wherein optionally the malocclusion or condition comprise a Class I, Class II or Class III malocclusion, or the malocclusion or condition comprises an overbite, underbite (or anterior crossbite), crossbite, overcrowding, spacing problem, open bite, overjet, or a diastema, comprising administering to an individual in need thereof a precision orthodontic device or appliance as described herein or made using a method as described herein.

In some embodiments, provided are precision orthodontic device or appliance having a pre-defined thickness or thicknesses, wherein the precision orthodontic device or appliance is fabricated or manufactured to cover all or a portion of (optionally 1% to 99% of) the surface of one or more or all teeth in an arch, and optionally the arch is a mandibular (lower) arch or a maxillary (upper) arch. In some embodiments, the pre-defined thickness or thicknesses are determined (or pre-defined) to enable the precision orthodontic devices or appliances as provided herein to express or apply varying amounts of retentive forces or orthodontic movement forces to the patient's dentition.

In some embodiments, provided are orthodontic appliances or devices having pre-defined thickness or thicknesses made by a process comprising the steps of: a) importing into a computer aided design (CAD) computer program a digitized data set obtained from a three-dimensional scan of a patient's dentition; b) preparing a three-dimensional electronic model of the patient's dentition; c) subtracting the three-dimensional electronic model of the patient's dentition from an image of a solid block or material to obtain an appliance data set; and d) manufacturing the orthodontic appliance or device in accordance with the appliance data set, wherein the fabricated precision orthodontic device or appliance has a pre-defined thickness or thicknesses. In some embodiments, the orthodontic devices provided herein are made by additive manufacturing methods such as 3-dimensional printing and/or injection molding; and in some embodiments, orthodontic devices provided herein are made by subtractive manufacturing processes such as carving and milling.

In some embodiments, the precision orthodontic devices or appliances are fabricated to cover all the teeth in an arch, for example, all mandibular (lower) or all maxillary (upper) teeth; or, alternatively, a precision orthodontic device or appliance as provided herein only covers a portion of an arch (optionally only a portion of a mandibular (lower) or a portion of a maxillary (upper) arch), for example, only covers one, two, three, four, five, six, seven, eight, nine, ten, eleven, twelve, thirteen, fourteen, fifteen or all sixteen teeth in an arch.

In some embodiments, the precision orthodontic devices or appliances are fabricated to move one or more teeth, or to stabilize the position of one or more teeth.

In some embodiments, the precision orthodontic devices or appliances are fabricated for mandibular or maxillary expansion, and optionally the precision orthodontic devices or appliances as provided herein can be attached or stabilized directly onto bone using for example wires, bone screws and/or pins.

Depending on the desired result (on treatment planning), if some teeth require more torque or applied force for movement, this can be done by designing alternative precision orthodontic device or appliance shapes and/or thicknesses. In some embodiments, varying dimensions of precision orthodontic devices or appliances as provided herein are fabricated to create a more controlled and designed force for tooth movement or for mandibular or maxillary expansion.

In some embodiments, the fabricated precision orthodontic devices or appliances have a pre-defined thickness that is consistent throughout the entire device or appliance; for example, the thickness of the entire device or appliance can be designed and fabricated to be between about 0.5 mm and 5 mm, or about 0.5 mm, 1 mm, 1.5 mm, 2 mm, 2.5 mm or 3 mm. In some embodiments, the fabricated precision orthodontic devices or appliances have a pre-defined but varying thicknesses, for example, cusp tips or occlusal contact points can be pre-defined to have one thickness (for example, between about between about 0.2 mm to 2 mm, or about 0.5 mm to 1.5 mm), and supporting (or non-occlusal) sections of the device or appliance can have a different thickness (for example, between about 2 mm to 2.5 mm or 5 mm). In some embodiments, the fabricated precision orthodontic devices or appliances have a pre-defined thickness or thicknesses to be able to apply varying amounts of retentive forces or orthodontic movement forces to the patient's dentition, or to stimulate or generate movement by the mandible or maxilla.

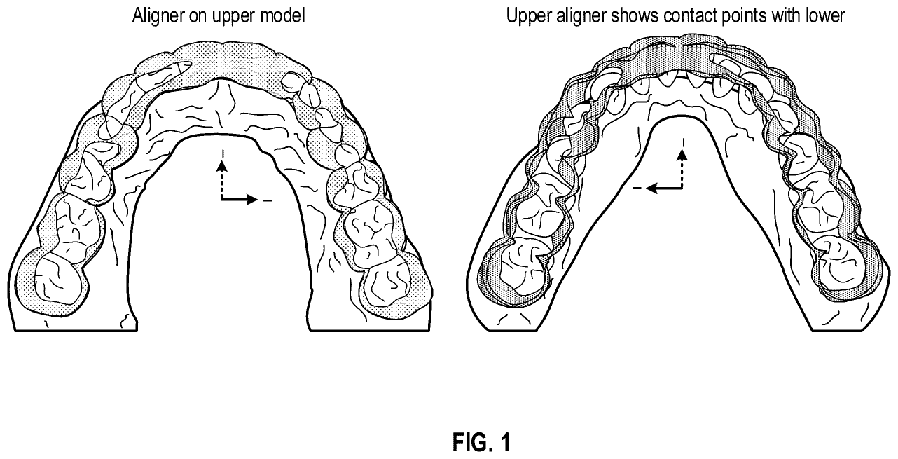

In some embodiments, precision orthodontic devices or appliances as provided herein are fabricated to solve to problems associated the teeth, particularly anterior teeth, not being able to contact each other. In some embodiments, precision orthodontic devices or appliances as provided herein are fabricated using the defined milling or manufacturing (for example, 3D additive printing and/or injection molding, and/or subtractive manufacturing methods) processes as provided herein to provide precision orthodontic devices or appliances allowing for tooth to tooth contact on occlusal surfaces. For example, FIG. 1 illustrates precision orthodontic devices or appliances fabricated to allow for tooth to tooth contact on occlusal surfaces in some embodiments. In some embodiments, precision orthodontic devices or appliances as provided herein are fabricated to allow for tooth to tooth contact on occlusal surfaces, for example, referring to FIG. 1. In some embodiments, tooth contacts are first identified so the dimensions of the desired orthodontic device or appliance, which is based on a three-dimensional scan of a patient's dentition, is designed to allow some tooth to tooth contact, for example, tooth to tooth contact on anterior occlusal surfaces (or incisor or incisor and canine occlusal surfaces), or tooth to tooth contact on both anterior and posterior (for example, molar and premolar) occlusal surfaces; the tooth to tooth contact open section of the precision orthodontic devices or appliances are incorporated in the appliance data set to accommodate fabrication of the device.

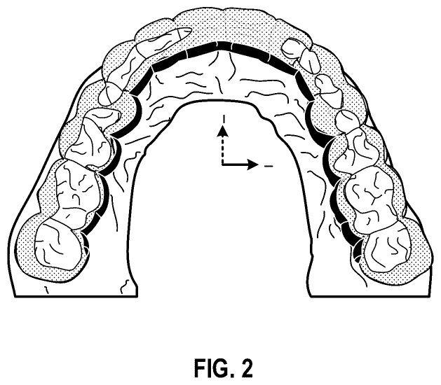

In some embodiments, precision orthodontic devices or appliances as provided herein are fabricated with respect to achieving molar to molar distances according to a setup model or target model, for example, by engineering and incorporating reinforcement members to exemplary orthodontic devices or appliances. For example, FIG. 2 illustrates an orthodontic device or appliance fabricated with respect to achieving molar to molar distances according to a setup model or target model. For example, if a patient needs to have mandibular arch form expansion, a lingual bar (for example, a metal bar) is added to or fabricated into the precision orthodontic device or appliance as provided herein to add rigidity, and optionally one or more clasps, wires or bars (optionally metal clasps, wires or bars) are inserted or fabricated into an orthodontic device or appliance as provided herein, and optionally dimensions of part of or the entire orthodontic device or appliance is varied to produce a more specifically desired, and thus more effective treatment.

### Methods of Manufacturing

In some embodiments, provided are methods for manufacturing or fabricating precision orthodontic devices and appliances from a solid block or material in accordance with the appliance data set, wherein the fabricated precision orthodontic device or appliance has a pre-defined thickness or thicknesses as described herein. Any manufacturing or fabricating process known in the art can be used, for example, as described in U.S. Pat. No. 9,299,192 (describing systems for creating and interacting with three dimensional virtual models); U.S. Pat. No. 9,358,082 (describing computer based virtual planning of dental devices); U.S. Pat. No. 8,352,060 (describing fabricating a dental prosthesis using high resolution digital scanned images of a patient's oral structures); U.S. Pat. Nos. 9,808,327; 10,213,280; 11,607,183; 11,484,390 (describing making 3D-printed orthodontic aligners); and U.S. patent application publications: US 2005 0089822 A1 (describing systems for interactive computer-aided design (CAD) in dental applications); US 2021 0259809 A1 (describing making 3D-printed orthodontic devices); US 2021 0147672 A1 (describing polymeric materials that can be used to fabricate orthodontic devices); US 2021 0002396 A1 (describing using photopolymerizable monomers as reactive diluents in a high temperature lithography-based photopolymerization process to make orthodontic appliances). The disclosures of the foregoing references are incorporated herein by reference in their entireties.

In some embodiments, provided are methods for manufacturing or fabricating precision orthodontic devices and appliances using three dimensional (3D) printing, for example, as described in U.S. Pat. No. 9,717,568 (describing making dental devices by 3D printing); U.S. Pat. No. 10,073,424 (describing computer program products for improving 3D printing systems and techniques); U.S. Pat. No. 10,470,855 (describing fabrication of dental devices using three-dimensional (3D) printing); U.S. Pat. No. 10,441,689 (describing methods and devices for three-dimensional printing or additive manufacturing of medical devices); U.S. Pat. No. 10,800,934 (describing processes for 3D printing a 3-dimensional (3D) object); and U.S. patent application publication US 2019 0269815 A1 (describing medical devices made from fibers and meshes of poly(butylene succinate) and copolymers thereof, by 3D printing); US20220110718 A1 (describing modular fabrication of dental apparatuses using three-dimensional (3D) printing); US 2019 0163060 A1 (describing building a three-dimensional object using a printable composition including high viscosity polymerizable components); US 2021 0355262 A1 (describing making orthodontic articles using a polycarbonate diol); US 2020 0332046 A1 (describing using stereolithography and inkjet printing to produce three-dimensional articles). The disclosures of the foregoing references are incorporated herein by reference in their entireties.

In some embodiments, dentists and health care practitioners can digitally design a desired oral appliance specific to an individual patient's dentition and clinical needs, and then using processes as provided herein manufacture the oral appliance using an automated manufacturing machine, such as for example: an automated milling machine, a 3-dimensional printer, a laser ablation, and the like. By using processes as provided herein, multiple oral appliances that are nearly identical in all respect, save for minor, designed adjustments, can be made. The appliances can be tested by the dentist or health care practitioner and patient to see which appliance iteration or version works best for treating any particular condition. As the patient's anatomy improves or changes, readjustment of the appliance becomes necessary. Replacement of an existing appliance can simply be manufactured from the stored digital file (whereas by traditional methods the patient needed to be recalled in for new impressions). By employing the methods as provided herein, a new appliance can be made in which an adjustment (for example, a minor change if fit, for example, to move a tooth or expand a palate or mandible) is the only noticeable change in the fit from the previously used appliance.

In some embodiments, the differences between the two appliances are within the tolerance of the manufacturing device, which tolerance is significantly smaller than if the two appliances were manufactured by hand. In some embodiments, the measured difference between two appliances in any of the length, width, height, thickness, and distance between two points in an appliance is <0.5 mm, <0.1 mm, <0.05 mm, or <0.01 mm. In some embodiments, the difference between two appliances in any of the length, width, height, thickness, and distance between two points one appliance is <5%, <1%, <0.5%, or <0.1% of the measured values.

In some embodiments, at the start of the process, a health care provider (HCP) examines the patient and obtains an impression of the patient's dentition, and models the bite by taking a bite impression in one or more positions of the mandible relative to maxilla. The impressions can be taken traditionally with dental impression material and poured up in stone or plaster either at the HCP office or at a manufacturing location (MFG).

In some embodiments, an electronic or digital image of the dentition, for example, the upper and or lower arch, are imaged directly from an electronic image (a digital image) visualizing of the patient's teeth. In some embodiments, the HCP provides photographs or digital images of the patient's dentition, and a computerized three-dimensional image of the patient's dentition can then be prepared. In some embodiments, the patient's dentition is scanned directly, while In some embodiments, the stone or plaster model of the patient's dentition is scanned. The scanning data is used to create a computerized three-dimensional image of the patient's dentition.

In some embodiments, the three-dimensional image of the patient's dentition is the image of the patient's bite when the patient is sleeping. In some embodiments, the patient's upper and lower dentitions are set in centric occlusion, while In some embodiments, the two dentitions are set in offset position to each other. The offset position is referred to as a “sleep bite” or “purposeful orthodontic protrusion.”

In some embodiments, the three-dimensional image is either obtained digitally, or is converted to a digital file. The digital file of the image is then imported into a computer aided design (CAD) software for designing the oral appliance.

In some embodiments, once the digitized image of the patient's dentition is obtained, the MFG provides the HCP with a completed image of the patient's bite, for example as a digitized image or a hardcopy print out, so that the HCP can determine if the bite is in the proper location. The HCP can, if necessary, make modifications on the image to the location of mandible with respect to maxilla. This adjustment would reflect, per the HCP's professional opinion, the best alignment for the patient's jaw for the treatment. In some embodiments, the MFG incorporates within the CAD software standard designs for the oral appliance and any features or accessories (see below) that the HCP may have requested; the digitized image of the appliance can be mathematically manipulated within the CAD software. These designs are general and basic, but can be modified, as discussed below, to match the particular needs of the individual patient.

In some embodiments, when the oral appliance comprises an upper jaw component and a lower jaw component, the components are designed independently and consecutively. In some embodiments, both components are designed simultaneously.

In some embodiments, an image of a solid block is superimposed over the image of the patient's lower dentition. The solid block image follows the general contours of the desired oral appliance. For instance, if the desired oral appliance is a mandibular advancement splint, then the solid block has a basic (i.e., featureless) “U” shaped design, where the ends of the “U” fit over the molars and the curvature of the “U” fits over the incisors. Similarly, if the desired oral appliance is an AM positioner, then the solid block would have a basic rectangular block design. Other block shapes that resemble a well-known geometric shape, such as triangular, square, rhomboid, and the like, blocks, and blocks having a random shape are also contemplated.

In some embodiments, a Cartesian coordinate system is used to better define the position of the oral appliance. In some of these embodiments, they axis is a part of the patient's sagittal plane, is parallel to the longitudinal axis, and points towards the roof of the patient's mouth and the head. The x and z axes are parts of the patient's transverse plane. The x axis is parallel to the media-lateral axis and points buccally to the left. The z axis is parallel to the sagittal axis and points anteriorly.

In some embodiments, when the solid block is positioned over the dentition, the block has four different surfaces. The lower surface, i.e., a surface parallel to the transverse plane and away from the gingiva, is the “occlusal plane” of the appliance. The upper surface, parallel to the transverse plane and near the gingiva, is the “gingival plane.” The curved plane in the interior of the “U,” i.e., the plane near the tongue, is the “lingual plane,” while the curved plane in the exterior of the “U,” i.e., the plane near the cheek, is the “buccal plane.”

In some embodiments, the gingival plane of the oral appliance is placed at the height of contour of one of the molars. “Height of contour” is a point visible to the eye on the buccal side of the molar, where the tooth is widest along the xz plane (e.g., where the tooth has the widest radius along the either the x or the z axis). In some embodiments, the molar is chosen arbitrarily. In some embodiments, the molar is either the furthest posterior tooth, or the penultimate posterior tooth (e.g., any one of teeth 17-19 or 30-32). For the purposes of this discussion, the “height of contour” represents a point on the buccal side of the tooth.

In some embodiments, a “contour curve” is obtained by connecting the heights of contour of all the teeth, and then smoothing the curve such that the curve has a quasi-sinusoidal shape, i.e., it smoothly rises and drops as the height of contour of each tooth is located above or below the height of contour of the respective preceding tooth. In some embodiments, the contour curve is placed at an offset distance at the buccal side of the dentition, while In some embodiments, the contour curve is placed at an offset distance at the lingual side of the dentition. The offset distance is the distance between a tooth and the device in the xz, xy, and/or yz plane(s). The offset distance provides, inter alia, room for the oral appliance to be placed over the dentition, which placement generally follows along they axis, without a fit that is too tight to cause discomfort for the patient. In some embodiments, the offset distance is a fraction of the visible buccal or lingual height of one of the posterior-most molars. The offset distance can be between about 0% to about 100% of the tooth height. In some embodiments, the offset distance is between about 20% to about 80% of the tooth height. In some embodiments, the offset distance is between about 0.01-about 0.5 mm. In some embodiments, the offset distance is between about 0.001-about 1.0 mm, while In some embodiments, the distance is greater than about 1.0 mm (e.g., about 1.1, about 1.3, about 1.5, about 1.7, about 1.9, or about 2.0 mm).

Throughout the present disclosure, the terms “up,” “upper,” or “upward,” and “down,” “lower,” or “downward” refer to the relative position of the upper jaw and the lower jaw. Thus, “protruding downwardly” means protruding away from the upper jaw and towards the lower jaw. Accordingly, for the lower splint, “lower” means away from the occlusal plane and towards the gingiva, while “upper” means away from the gingiva and towards the occlusal plane. Likewise, for the upper splint, “lower” means away from the gingiva and towards the occlusal plane, while “upper” means away from the occlusal plane and towards the gingiva. Similarly, the words “front” or “forward” and “back” or “backward” refer to the relative position of components in the mouth. Thus, “front” means towards the lips (anteriorly), whereas “back” means towards the throat (posteriorly), when the device is in the mouth.

In some embodiments, the offset distance is the same as one moves around the device along the xz plane. In some embodiments, the offset distance varies as one moves around the device along the xz plane. In these embodiments, the offset distance is calculated for each single tooth or for a collection of few neighboring teeth. In some embodiments, the variance due to manufacturing limitations for the actual offset distance (i.e., the offset distance of the manufactured device) is <25%, <20%, <10%, <5%, or <1% of the calculated offset distance.

In some embodiments, the offset is tapered. In these embodiments, the offset is larger at the gingival plane of the device and gradually becomes smaller as one moves towards the occlusal plane. In these embodiments, as the patient places the device over the patient's dentition, the device moves over the dentition loosely at first, but the grip becomes tighter as the device is pressed further over the dentition. Additionally, in some embodiments the offset is tapered in the anterior-posterior direction, providing a variance in tightness for each tooth along the length of the upper or lower arch. In some embodiments, the offset is tapered in the occlusal-gingival direction. In some embodiments, the offset is specific for each tooth. In yet other embodiments, the HCP or the MFG designs and tapers the offset for a single targeted tooth. In some of these embodiments, the tooth-specific offset is then taken as a model for the offset tapering for other teeth. This variance may be customized to the patient's particular dentition or preference for comfort and fit.

In some embodiments, “about” a certain value it is meant that the stated value comprises the range of values within ±25%, ±20%, ±10%, or ±5% of the stated value. Thus, by way of example only, if a distance is given as “about 5 mm,” the range of distances between 3.75 mm (5-25%) to 6.25 mm (5±25%) is envisioned.

In some embodiments, the contour curve is then moved along the y axis toward the gingival plane and away from the occlusal plane (i.e., the curve is moved “up”). If the gingival plane of the oral appliance is placed exactly at the contour curve, then the grip of the appliance on the dentition will be somewhat weak. However, if the contour curve is placed between the contour curve and the gingival plane, then the oral appliance will grip the dentition more strongly. The closer the contour curve is to the gingival plane, the stronger the grip. If the contour curve is too close to the gingival plane, then the patient will experience discomfort when the oral appliance is placed in the mouth or is removed from the mouth. In some cases, the grip will be too strong to remove the oral appliance, and can lead to the loosening of one or more of the teeth. Similarly, if the contour curve is placed too far from the gingival plane, then the oral appliance will be too loose during use and may inadvertently fall out. In some embodiments, the contour curve is moved towards the appliance's gingival plane by a distance that is a fraction of the visible buccal or lingual height of one of the posterior-most molars. In some embodiments, the fraction is between about 0% to about 100%, while In some embodiments, the fraction is between about 1% to about 50%, and In some embodiments, the fraction is between about 0.1% to about 90%.

In some embodiments, following the placement of the contour curve, the portion of the solid block between contour curve and the gingival surface is subtracted from the solid block to obtain a contour block. At this point, the gingival plane is no longer a 2-dimensional plane. The plane, now termed “gingival surface,” is a curved surface whose curvature matches that of the contour curve.

Thus, in some embodiments, the lingual contour curve is moved “up” 100%, such that the appliance no longer has a lingual wall, while the buccal contour curve is moved “up” by 20%, meaning that the buccal wall retains most of its original height. Similarly, In some embodiments, the buccal contour curve is moved up 100% while the lingual contour curve is moved up by 20%. In yet other embodiments, both lingual and buccal contour curves are moved up by a fraction <100%. In some of these embodiments, the two contour curves are moved by the same fraction, while In some embodiments, the two contour curves are moved by different fractions.

In some embodiments, the three-dimensional electronic model of the patient's dentition is subtracted from the contoured block to obtain an appliance data set. The data set is then communicated with a manufacturing device and an oral appliance is made in accordance with the appliance data set.

In some embodiments, the digitized data set can be obtained from: i) scanning a model of the patient's dentition; ii) the patient's dentition directly; iii) X-ray image of the patient's dentition; iv) computed tomographic (CT) scan of the patient's dentition; v) magnetic resonance image (MRI) of the patient's dentition; vi) digitized photographs of the patient's dentition, or any combination of i) to vi). In some embodiments, the digitized data set is created in the HCP's office, having direct contact with the patient, while In some embodiments, the digitized data set is created in the MFG.

In some embodiments, the methods described herein can further comprise the step of mathematically including the image of an appliance accessory, or an appliance accessory connection point, to the appliance data set. In some embodiments, the image of the accessory or its connection point is added to the electronic image of the splint. In some embodiments, the image of the accessory or its connection point are subtracted from the original solid block.

In some embodiments, the appliance accessory is selected from the group consisting of a compliance chip, an electronic or microelectronic device, a “smart” accessory (i.e., an electronic device that obtains data and communicates the data with another electronic device), strap, affixed sleeve, removable sleeve, straps, anterior hinge, short or long Herbst, jack screw, and Herbst hinge in combination with jack screw, or any other appliance accessory now known or designed in the future.

In some embodiments, the accessory is a separate manufacture than the dental device. In these embodiments, the accessory itself is attached to the device after the manufacturing of the device. In some embodiments, the accessory is part of the unitary design of the device. In these embodiments, the accessory comes to being at the same time the device is manufactured.

In some embodiments, the methods provided herein can further comprise the step of mathematically including (by adding or subtracting) the image of an appliance design feature to the appliance data set. In some embodiments, and an appliance design feature can comprise: a fin, anterior opening, anterior discluder, scalloped occlusal opening, lingual opening, a tapered posterior, a tongue attractor, lingualess, full lingual coverage, edentulous, posterior lingual, anterior lingualess, and/or a monoblock.

In some embodiments, the appliance design feature can be pre-programmed into the CAD software. In some embodiments, the MFG modifies or manipulates the pre-programmed design feature to create a unique design feature (i.e., shape, placement location, size, and the like) that meets the unique needs of the patient.

In some embodiments, the appliance can be manufactured additively. In some embodiments, the appliance can be manufactured subtractively. By “additive manufacturing” it is meant that the future device begins at a nucleus and grows from the nucleus.

Examples of additive manufacturing can include a fused deposit molding (FDM) additive manufacturing process, 3-dimensional printing (where the device grows out of a pool of monomers), and, injection molding (where the mold is filled with the monomer). By “subtractive manufacturing” it is meant that the future device is carved out of a block of material. Examples of subtractive manufacturing include hand carving and milling.

In some embodiments, the appliance can be manufactured automatedly or robotically.

In some embodiments, the appliance is manufactured by a method selected from the group consisting of milling a block, injection molding, three-dimensional printing, computer-aided manufacturing technology, or a combination thereof.

In some embodiments, the appliance can be manufactured by a combination of two or more subtractive manufacturing techniques, or by a combination of two or more additive manufacturing techniques, or by a combination of one or more subtractive manufacturing techniques and one or more additive manufacturing techniques.

In some embodiments, the appliance can be made of a material that is physiologically compatible or acceptable to human soft tissue, has sufficient strength for the desired function but malleable enough to be conveniently placed over the dentition, and/or is not repugnant (for example, in taste or smell) to the patient when placed in the mouth.

In some embodiments, the appliance can include or can be manufactured from a polymer, a composite, a thermoplastic, a thermoset, and the like. In some embodiments, the appliance can be subtractively manufactured from a block of, or additively manufactured to form, a material comprising: poly(butylene succinate) and copolymers thereof, polymethyl-methacrylate (PMMA), lined PMMA, high-strength polyether ether ketone (PEEK), a (meth)acryloyloxy-substituted benzoic acid ester, urethane di(meth)acrylate (UDMA), triethyleneglycol dimethacrylate (TEGDMA), tetraethylene glycol diacrylate (E4-A), trimethylolpropanetriacrylate (TTA), a polymer matrix comprising diurethanedimethacrylate (DUDMA) and glycerol dimethacrylate (GDMA), a polymer produced from polyoxymethylene and acetal copolymers (DURACETAL®), glycol modified polyethylene terephthalate (PETg), a physiologically compatible, water insoluble, non-malleable polymer, wood, plastic, and/or, a metal.

In some embodiments, a manufacturing process may comprise preparing a three-dimensional electronic model of the patient's dentition, superimposing an image of a solid block over the electronic model of one of the patient's upper or lower dentition, wherein optionally the solid block has a “U” shape that approximates the curvature of the patient's dentition, and wherein optionally the gingival surface of the solid block is at about the height of contour of a molar tooth of the dentition, determining the contour curve for the dentition, wherein the contour curve is placed at an offset distance at either the buccal or lingual side of the dentition, wherein the offset distance is between about 20% to about 80% of the visible tooth height of one of the posterior-most molars, moving the height of contour curve towards the gingival line by a distance of about between about 1% to about 50% of the visible tooth height of one of the posterior-most molars, subtracting the portion of the solid block below the height of contour curve to obtain a contoured block, subtracting the three-dimensional electronic model of the patient's dentition from the contoured block to obtain an appliance data set, automatedly manufacturing a orthodontic appliance in accordance with the appliance data set, wherein the fabricated precision orthodontic device or appliance has a pre-defined thickness or thicknesses.

In some embodiments, an exemplary manufacturing process comprises an additive manufacturing process: the machine, robot or designer begins with an empty space or nucleus and gradually adds features of the device until the device design is completed. In some embodiments an exemplary digital additive design comprises:
a) preparing a three-dimensional electronic model of the patient's dentition,
b) design a “U” shaped surface covering the patient's dentition,
c) adding walls, on either the lingual side, the buccal side, or both up to the contour curve, and/or
d) adding the scalloped features of the patient's dentition, wherein the fabricated precision orthodontic device or appliance has a pre-defined thickness or thicknesses.

In some embodiments, the fabricated precision orthodontic devices or appliances have a pre-defined thickness or thicknesses to be able to apply varying amounts of retentive forces or orthodontic movement forces to the patient's dentition, or to stimulate or generate movement by the mandible or maxilla.

In some embodiments, manufacturing methods as provided herein can comprise additive design methods and subtractive design methods. In some embodiments, precision orthodontic devices or appliances as provided herein are designed by a combination of additive and subtractive methods. For example, in some embodiments, a precision orthodontic device or appliance as provided herein is designed subtractively while the inclusion of the accessories is designed additively. In some embodiments, precision orthodontic device or appliance as provided herein are designed additively, then subtractive method applied. In some of these embodiments, a feature (for example, a lingual wall) is added, but then the feature is subtractively reduced until the desired feature is obtained (for example, a wall height is subtracted up to the contour curve).

In some embodiments, a feature, such as an extrusion, is designed in CAD. In some embodiments, the feature is a group of features that are designed and then merged together in CAD to make a desired and complete precision orthodontic device or appliance as provided herein. In some embodiments, the designed feature comprises a standard and well-defined geometrical shape, for example a cube, a pyramid, a cone, a cylinder. A well-defined geometrical shape is one in which the cross section of the feature is a standard geometrical shape of a circle, a square, a rectangle, a parallelogram, a circle, a triangle, a rhombus, and the like. In some embodiments, the feature comprises a customized shape. The customized shape is one in which the cross section is a non-standard, or amorphous, geometrical shape. In some embodiments, the feature is entirely made up of one, or a merger of two or more, standard geometrical shapes. In some embodiments, the feature is entirely made up of one, or a merger of two or more, non-standard geometrical shapes. In some embodiments, the feature comprises between 10%, 20%, 30%, 40%, 50%, 60%, 70%, 80% or 90% of one or more standard geometrical shape(s), with the remainder being comprised of one or more non-standard shape(s).

In some embodiments, the feature (for example, a tapered offset) is adjusted in an iterative process of addition and subtraction (for example at least two cycles of addition and subtraction) until an optimized design (for example, a taper that fits the patient's dentition very well) is obtained.

In some embodiments, provided are methods of treating, preventing or ameliorating a condition (such as a malocclusion or sleep breathing disorder) in a patient, the method comprising: identifying a patient in need thereof, designing and fabricating a precision orthodontic device or appliance as provided herein, and positioning the orthodontic device or appliance in the patient's mouth, such that the condition is treated or ameliorated. In some embodiments, the condition is a sleep breathing disorder. In some embodiments, the condition is one in which the repositioning of the patient's dentition treats, prevents or ameliorates the condition. Examples of the conditions include, but are not limited to, sleep apnea, teeth grinding, and improperly positioned maxillary or mandible, for example, treating or ameliorating a prognathic or a retrognathic maxilla or mandible. In some embodiments, the condition is a malocclusion, wherein the malocclusion can be a Class I, Class II or Class III malocclusion, or the malocclusion or condition can be an overbite, underbite (or anterior crossbite), crossbite, overcrowding, spacing problem, open bite, overjet, or a diastema.

In some embodiments, the MFG location is a facility outside of the HCP's office, for example, a third party manufacturing facility. In some embodiments, the HCP's office features a milling, 3D imaging, or other manufacturing, capability that can manufacture the oral appliance.

### Kits

In some embodiments, provided are kits comprising orthodontic devices or appliances as provided herein, and for practicing methods as provided herein. In some embodiments, products of manufacture and kits can further comprise instructions for practicing methods as provided herein.

In some embodiments, provided are kits comprising both a mandibular (lower) arch orthodontic device or appliance and a maxillary (upper) arch orthodontic device or appliance, i.e., a set of upper and lower orthodontic devices or appliances.

In some embodiments, provided are kits comprising two or more mandibular (lower) arch orthodontic devices or appliances, wherein each of the two or more mandibular orthodontic devices or appliances has a different design or shape, for example, the two or more mandibular orthodontic devices or appliances are designed to be consecutively by the patient for mandibular tooth movement or mandibular or palatal expansion.

In some embodiments, provided are kits comprising two or more maxillary (upper) arch orthodontic devices or appliances, wherein each of the two or more maxillary orthodontic devices or appliances has a different design or shape, for example, the two or more maxillary orthodontic devices or appliances are designed to be consecutively by the patient for maxillary tooth movement or palatal or maxillary expansion.

In some embodiments, provided are kits comprising two or more maxillary (upper) arch orthodontic devices or appliances as provided herein, and two or more mandibular (lower) arch orthodontic devices or appliances as provided herein.

Any of the above aspects and embodiments can be combined with any other aspect or embodiment as disclosed here in the Summary, Figures and/or Detailed Description sections.

As used in this specification and the claims, the singular forms “a,” “an” and “the” include plural referents unless the context clearly dictates otherwise.

Unless specifically stated or obvious from context, as used herein, the term “or” is understood to be inclusive and covers both “or” and “and”.

Unless specifically stated or obvious from context, as used herein, the term “about” is understood as within a range of normal tolerance in the art, for example within 2 standard deviations of the mean. About (use of the term “about”) can be understood as within 20%, 19%, 18%, 17%, 16%, 15%, 14%, 13%, 12% 11%, 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless specifically stated or obvious from context, as used herein, the terms “substantially all”, “substantially most of”, “substantially all of” or “majority of” encompass at least about 75%, 80%, 85%, 90%, 91%, 92%, 93%, 94%, 95%, 96%, 97%, 98%, 99% or 99.5%, or more of a referenced amount of a composition. In some embodiments, when a precision orthodontic device or appliance is fabricated or manufactured not to cover, or substantially not cover, one or more or all occlusal surfaces on the teeth (or tooth), is does not cover about 75%, 80%, 85%, 90%, 91%, 92%, 93%, 94%, 95%, 96%, 97%, 98%, 99% or 99.5%, or more of the occlusal surfaces on the teeth (or tooth).

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents. Incorporation by reference of these documents, standing alone, should not be construed as an assertion or admission that any portion of the contents of any document is considered to be essential material for satisfying any national or regional statutory disclosure requirement for patent applications.

Notwithstanding, the right is reserved for relying upon any of such documents, where appropriate, for providing material deemed essential to the claimed subject matter by an examining authority or court.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, and yet these modifications and improvements are within the scope and spirit of the invention. The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. Thus, the terms and expressions which have been employed are used as terms of description and not of limitation, equivalents of the features shown and described, or portions thereof, are not excluded, and it is recognized that various modifications are possible within the scope of the invention. Embodiments of the invention are set forth in the following claims.

A number of embodiments of the invention have been described. Nevertheless, it can be understood that various modifications may be made without departing from the spirit and scope of the invention. Accordingly, other embodiments are within the scope of the following claims.

What is claimed is:

1. An appliance comprising:
an appliance body including a portion shaped to match a contour of a tooth in an arch, the appliance body configured to couple to the arch to cover about 20% or more and about 99% or less of a surface of the tooth.

2. The appliance of claim 1, wherein the arch is a mandibular arch or a maxillary arch.

3. The appliance of claim 1, wherein the appliance body is configured to cover only a portion of an occlusal surface on the tooth or an anterior occlusal surface on the tooth.

4. The appliance of claim 1, wherein the appliance body is configured to cover up to 99% of an occlusal surface on the tooth or 99% of an anterior occlusal surface on the tooth.

5. The appliance of claim 1, wherein the appliance body has an opening to allow a tooth to tooth contact on an anterior occlusal surface through the opening.

6. The appliance of claim 1, wherein the appliance body is configured to cover only a portion of an incisor surface, a canine surface, a posterior occlusal surface, or any combination thereof.

7. The appliance of claim 1, wherein the appliance body is configured to cover only a portion of a molar surface or a premolar surface.

8. The appliance of claim 1, wherein the appliance body is configured to cover a plurality of teeth.

9. The appliance of claim 1, wherein the appliance body is configured to perform palatal expansion or maxillary expansion.

10. The appliance of claim 1, wherein the appliance body is configured to be coupled to a bone using a bone wire, a bone screw, a bone pin, or any combination thereof.

11. The appliance of claim 1, the appliance body has a thickness of from about 0.5 mm to about 5 mm.

12. The appliance of claim 1, further comprising:
a clasp, a wire, a bar, or any combination thereof; or
a strap, an affixed sleeve, a removable sleeve, a strap, an anterior hinge, a short or long Herbst, a jack screw, a Herbst hinge, or any combination thereof.

13. The appliance of claim 1, further comprising a sensor, a light emitting device, or any combination thereof.

14. The appliance of claim 1, further comprising a compliance chip, an electronic or microelectronic device, an electronic accessory to obtain data and communicates the data with another electronic device, or any combination thereof.

15. A method for making an appliance, the method comprising:
(a) importing into a computer aided design (CAD) computer program a digitized data set obtained from a three-dimensional scan of dentition to generate a three-dimensional electronic model of the dentition;
(b) inputting data to define dimensions of an appliance to be made based on the three-dimensional scan and a shape of the appliance, wherein the shape is defined by an effect of the appliance on the dentition, a mandibular or maxillary structure, or an alignment of the dentition;
(c) subtracting the three-dimensional electronic model of the dentition, and preserving the defined dimensions of the appliance, from an image of a virtual solid block or material to obtain an appliance data set; and
(d) fabricating the appliance from a solid block or material based on the appliance data set,
wherein the fabricated appliance has a pre-defined thickness.

16. The method of claim 15, wherein the manufacturing of the appliance comprises an additive manufacturing method.

17. The method of claim 15, wherein the manufacturing of the appliance comprises a fused deposit molding (FDM) additive manufacturing process, 3-dimensional printing, injection molding, or any combination thereof.

18. The method of claim 15, wherein the appliance is configured to cover only a portion of an occlusal surface on a tooth.

19. The method of claim 15, wherein the appliance is configured to cover up to 99% of an occlusal surface on a tooth.

20. A kit comprising at least one of the appliance of claim 1, and instructions for using the appliance.
